(19) United States
(12) Patent Application Publication
(10) Pub. No.: US 2026/0075160 A1
(43) Pub. Date: Mar. 12, 2026

(54) GENERATING INTERPOLATED IMAGE DATA

(71) Applicant: QUALCOMM Incorporated, San Diego, CA (US)

(72) Inventors: Arshia ERSHADI, Richmond Hill (CA); Alireza SHOA HASSANI LASHDAN, Burlington (CA); Vishnu Sanjay RAMIYA SRINIVASAN, Oshawa (CA)

(21) Appl. No.: 19/323,957

(22) Filed: Sep. 9, 2025

Related U.S. Application Data
(60) Provisional application No. 63/694,071, filed on Sep. 12, 2024.

(51) Int. Cl. H04N 7/01

(52) U.S. Cl. CPC H04N 7/014

(57) ABSTRACT

Systems and techniques are described herein for interpolating image data. For instance, a method for interpolating image data is provided. The method may include processing a first image frame and a second image frame using a motion estimator to generate first motion vectors, wherein the motion estimator comprises a machine-learning model trained to generate motion vectors based on image frames; projecting the first motion vectors to generate second motion vectors; and generating a third image frame based on the first image frame, the second image frame, and the second motion vectors.

### CROSS-REFERENCE TO RELATED APPLICATIONS

This application claims the benefit of U.S. Provisional Application No. 63/694,071, filed Sep. 12, 2024, which is incorporated herein by reference in its entirety.

### TECHNICAL FIELD

The present disclosure generally relates to imaging. For example, aspects of the present disclosure include systems and techniques for generating interpolated image data.

### BACKGROUND

Frame-interpolation (FI) methods are widely used in, as examples, camera, gaming, video streaming, virtual reality (VR), extended reality (XR), and generative artificial intelligence (AI) applications. FI may generally involve generating a frame to be displayed between two existing frames.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for interpolating image data. According to at least one example, a method is provided for interpolating image data. The method includes: processing a first image frame and a second image frame using a motion estimator to generate first motion vectors, wherein the motion estimator comprises a machine-learning model trained to generate motion vectors based on image frames; projecting the first motion vectors to generate second motion vectors; and generating a third image frame based on the first image frame, the second image frame, and the second motion vectors.

In another example, an apparatus for interpolating image data is provided that includes at least one memory and at least one processor (e.g., configured in circuitry) coupled to the at least one memory. The at least one processor configured to: process a first image frame and a second image frame using a motion estimator to generate first motion vectors, wherein the motion estimator comprises a machine-learning model trained to generate motion vectors based on image frames; project the first motion vectors to generate second motion vectors; and generate a third image frame based on the first image frame, the second image frame, and the second motion vectors.

In another example, a non-transitory computer-readable medium is provided that has stored thereon instructions that, when executed by one or more processors, cause the one or more processors to: process a first image frame and a second image frame using a motion estimator to generate first motion vectors, wherein the motion estimator comprises a machine-learning model trained to generate motion vectors based on image frames; project the first motion vectors to generate second motion vectors; and generate a third image frame based on the first image frame, the second image frame, and the second motion vectors.

In another example, an apparatus for interpolating image data is provided. The apparatus includes: means for processing a first image frame and a second image frame using a motion estimator to generate first motion vectors, wherein the motion estimator comprises a machine-learning model trained to generate motion vectors based on image frames; means for projecting the first motion vectors to generate second motion vectors; and means for generating a third image frame based on the first image frame, the second image frame, and the second motion vectors.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1A includes a first example set of image frames to illustrate an example of frame interpolation;

FIG. 1B includes a second example set of image frames to illustrate an example of frame interpolation;

FIG. 2A is a block diagram illustrating a first view of an example system that may generate an interpolated frame;

FIG. 2B is a block diagram illustrating a second view of the example system of FIG. 2A;

FIG. 3A is a diagram illustrating an example of a frame of a sequence of frames;

FIG. 3B is a diagram illustrating an example of a frame that is adjacent to the frame of FIG. 3A in the sequence of frames;

FIG. 3C is a diagram illustrating an example of a frame that is adjacent to frame FIG. 3B in the sequence of frames;

FIG. 4 is a block diagram illustrating an example system that may generate interpolated frames, according to various aspects of the present disclosure;

FIG. 5 is a block diagram illustrating an example implementation of the time-step motion-vector projector of FIG. 4, according to various aspects of the present disclosure;

FIG. 6 includes representations of an input frame, an interpolated frame, and an input frame to illustrate concepts related to the operation of confidence determiner;

FIG. 7 is a block diagram illustrating an example implementation of the motion-vector projector of FIG. 5, according to various aspects of the present disclosure;

FIG. 8A, FIG. 8B, and FIG. 8C are diagrams illustrating motion vectors and image frames to provide context for a description of concepts related to scaling and/or following motion vectors, according to various aspects of the present disclosure;

FIG. 9 and FIG. 10 are diagrams illustrating blocks in an image frame and motion vectors in relation to the blocks to provide context for a description of concepts related to following motion vectors according to various aspects of the present disclosure;

FIG. 11 includes an example implementation of the mask modulator of FIG. 5, according to various aspects of the present disclosure;

FIG. 12A is a flow diagram illustrating an example process for generating interpolated image data, in accordance with aspects of the present disclosure;

FIG. 12B is a flow diagram illustrating another example process for generating interpolated image data, in accordance with aspects of the present disclosure;

FIG. 13 is a block diagram illustrating an example of a deep learning neural network that can be used to perform various tasks, according to some aspects of the disclosed technology;

FIG. 14 is a block diagram illustrating an example of a convolutional neural network (CNN), according to various aspects of the present disclosure; and

FIG. 15 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Frame-interpolation (FI) methods are widely used in, as examples, cameras, gaming, video streaming, virtual reality (VR), extended reality (XR), and generative artificial intelligence (AI) applications. FI may generally involve generating a frame (or multiple frames) to be displayed between two existing frames.

In the field of image/video capture, FI may allow a frame rate to be low while outputting a high frame rate video, providing visually appealing videos at reduced computation. FI may be used in low-light scenes, to capture slow-motion video, and/or for intensity-change sensors, etc. For example, a camera may capture frames at 15 frames per second (fps). An FT module within the camera may generate a frame between each of the captured frames, storing a video with frames at 30 fps while capturing frames at 15 fps (which may be advantageous for low-light settings). As another example, an FI module within a camera may generate three frames between each of the capture frames, for example converting a video captured at 60 fps to 240 fps (which may be suitable for slow-motion video). As yet another example, intensity-change sensors may capture event data at very high frame rates. Intensity-change sensors capture changes in intensity from frame to frame (known as negative and positive events depending on direction of change). FI may be with in intensity-change sensors since there will be a conversion of frame rates needed to go between high and low frame rate data.

In the field of gaming, FI enables rendering images at low frames rates and inserting frames to get high frame rates while reducing power and saving compute time. For example, a graphics processing unit (GPU) may render frames at 15 fps. An FI module within the gaming system may generate a frame between each of the rendered frames, to display video with frames at 30 fps while rendering (at the GPU) frames at 15 fps (which may conserve power). Additionally or alternatively, FI may enable stable display frame rates when games are rendered at variable frame rates due to scene complexity.

In the field of video playback/streaming, FI enables constant display frame rate under varying bandwidth and connectivity. For example, a device may receive frames at 15 fps. An FT module within the device may generate a frame between each of the received frames, allowing a viewer to view video at 30 fps while conserving bandwidth by only receiving frames at 15 fps.

In the field of generative artificial intelligence (AI) video generation, FT enables generating content at higher frame rate while keeping the actual video generation at low fps. For example, a generative AI model may generate two frames, and FT may generate an interpolated frame between the two frames, effectively doubling the number of frames and allowing frames to be created at faster rates.

Machine-learning-based FT solutions provide higher quality interpolated frames compared to traditional solutions. Such solutions may use a machine-learning model trained to generate motion vectors (MVs) and a frame renderer configured to render frames based on input frames and motion vectors.

For on-device, real-time applications performance and quality are key performance indicators. For example, for on-device applications, keeping power consumption low may be important. For real-time applications, speed may be important.

Many FT pipeline estimate motion vectors and blend weights (e.g., a mask of blend weights) using input image frames and meta data. A frame renderer may then render an interpolated frame (or frames) based on the input image frames, the motion vectors, and/or the blend weights.

A good on-device frame-interpolation algorithm should have following properties: good visual interpolation quality, support high frame rate conversion (e.g., 30 to 120 fps), arbitrary time-step conversion to keep the output at constant frame rate (e.g., 24 to 120 fps), lower power than native high frame rate frame rate capture/rendering, and low latency to enable real-time applications.

For example, a good FT algorithm in a camera may convert a 4096-×-2160 (4k) resolution video, at 30 fps to a 4k resolution video at 120 fps. As another example, a good FT algorithm in a gaming application may convert a 1920-×-1080 (1080p) resolution video at 60 fps to 120 fps.

Arbitrary-time-step interpolation is the process of generating output interpolated frames to convert any integer input fps to any integer output fps (e.g. 30 fps to 120 fps, 24 fps to 60 fps, 25 fps to 60 fps, etc.). Arbitrary-time-step interpolation may insert interpolated frames in between original input frames.

To support arbitrary time step interpolation, current machine learning (ML) FT algorithms run one inference with the entire network (or multiple inferences) with parts of the network for a pair of frames at each time step (t). For example, for 30 to 120 fps interpolation, there are 3 inferences; one for each t per frame pair (t=0.25, t=0.50, t=0.75). Running multiple neural network inferences for each time step significantly increases power and latency.

Systems, apparatuses, methods (also referred to as processes), and computer-readable media (collectively referred to herein as “systems and techniques”) are described herein for generating image data. For example, the systems and techniques described herein may generate interpolated images data based on input image data.

Rather than running multiple inferences to generate multiple interpolated images between two image frames, the systems and techniques may run one network inference at a given time step and then project the estimated motion vectors and masks for other time steps. This results in lower power and latency since there is no other network inference and just a low-complexity post processing step needed.

For example, the systems and techniques may run network inference once to estimate motion vectors and occlusion masks that interpolate at one time-step. The systems and techniques may use a fixed low-complexity algorithm to project the motion vectors and occlusion masks to interpolate additional time-steps between 2 frames. The projection algorithm may be network agnostic and may process motion vectors and masks generated by the network for one time-step. The network may take multiple input types (frames, depth-map, game-engine motion vectors, etc.) with any network architecture (CNN, transformers, etc.) as long the network outputs motion vectors and occlusion masks for one time-step.

The systems and techniques may provide improvements over other frame-interpolation techniques. For example, the systems and techniques may consume less power and take less time than other frame-interpolation techniques.

For example, a given network inference run may consume 220 milliwatts (mW) of power and take 13 milliseconds (ms) to run. To perform a 4× interpolation (e.g., to increase a frame rate by 4×, such as from 30 fps to 120 fps), a conventional frame-interpolation technique may run the network inference 3 times (once for each interpolated frame generated by the network). The conventional frame-interpolation technique may consume 660 mW and take 39 ms.

In contrast, the projection technique of the systems and techniques may consume 10 mW and take 1 ms. To perform a 4× interpolation, the systems and techniques may use a network to generate a first frame and use the projection technique to generate the other two frames. According to this example, to perform the 4× interpolation, the systems and techniques may consume 240 mW and take 15 ms.

Various aspects of the application will be described with respect to the figures below.

As mentioned previously, arbitrary-time-step interpolation may generate output interpolated frames to convert any integer input fps to any integer output fps. Arbitrary-time-step interpolation may insert interpolated frames in between original input frames.

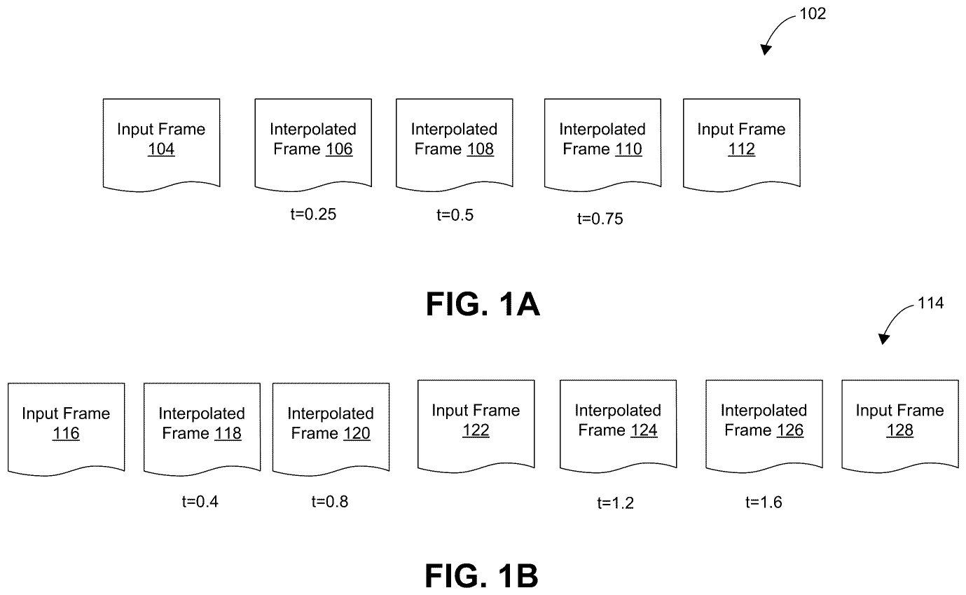

FIG. 1A includes a first example set of image frames 102 to illustrate an example of frame interpolation. Set of image frames 102 represents an example interpolation increasing a frame rate by four times. For example, set of image frames 102 may represent an increase from 30 fps to 120 fps. Set of image frames 102 includes an input frame 104 and an input frame 112 that may be received as input frames of a series of image frames. Set of image frames 102 includes an interpolated frame 106, an interpolated frame 108, and an interpolated frame 110 that may be generated by a frame-interpolation technique.

Set of image frames 102 may be evenly spaced in time. For example, input frame 104 may be associated with a timestamp t=0 and input frame 112 may be associated with a timestamp t=1. In cases in which the input image frames have a frame rate of 30 fps, t=1 may be 1/30 second after t=0. To evenly space interpolated frame 106, interpolated frame 108, and interpolated frame 110 in time between input frame 104 and input frame 112, interpolated frame 106 may be associated with a timestamp t=0.25, interpolated frame 108 may be associated with a timestamp t=0.5, and interpolated frame 110 may be associated with a timestamp t=0.75. At a frame rate of 120 fps, t=0.25 may be 1/120 second after t=0, t=0.5 may be 2/120 second after t=0, and t=0.75 may be 3/120 second after t=0.

FIG. 1B includes a second example set of image frames 114 to illustrate an example of frame interpolation. Set of image frames 114 represents an example interpolation increasing a frame rate by 2.5 times. For example, set of image frames 102 may represent an increase from 24 fps to 60 fps. Set of image frames 114 includes an input frame 116, an input frame 122, and an input frame 128 that may be received as input frames of a series of image frames. Set of image frames 114 includes an interpolated frame 118, an interpolated frame 120, an interpolated frame 124, and an interpolated frame 126 that may be generated by a frame-interpolation technique.

Set of image frames 114 may be evenly spaced in time. For example, input frame 116 may be associated with a timestamp t=0, input frame 122 may be associated with a timestamp t=1, input frame 128 may be associated with a timestamp t=2. In cases in which the input image frames have a frame rate of 24 fps, t=1 may be 1/24 second after t=0 and t=2 may be 1/24 second after t=1. To evenly space interpolated frame 118, interpolated frame 120, interpolated frame 124, and interpolated frame 126 in time between set of image frames input frame 116 and input frame 128, interpolated frame 118 may be associated with a timestamp t=0.4, interpolated frame 120 may be associated with a timestamp t=0.8, interpolated frame 124 may be associated with a timestamp t=0.1.2, and interpolated frame 126 may be associated with a timestamp t=1.6. Input frame 122 may be omitted. For example, if set of image frames 114 is being displayed, input frame 122 may not be displayed and input frame 116, interpolated frame 118, interpolated frame 120, interpolated frame 124, interpolated frame 126, and input frame 128 may be displayed. At a frame rate of 60 fps, t=0.4 may be 1/60 second after t=0, t=0.8 may be 2/60 second after t=0, t=1.2 may be 3/60 second after t=0, and t=1.6 may be 4/60 second after t=0.

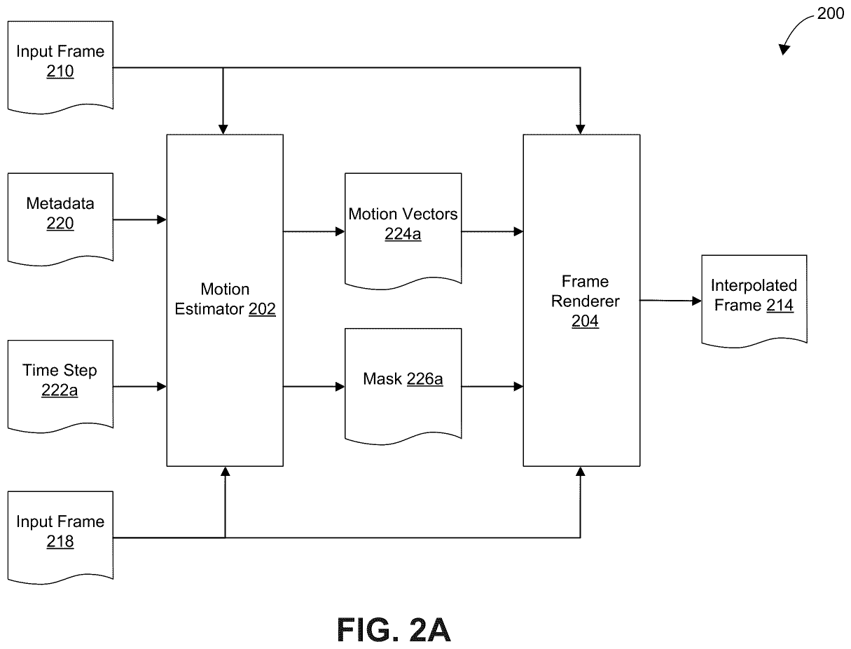

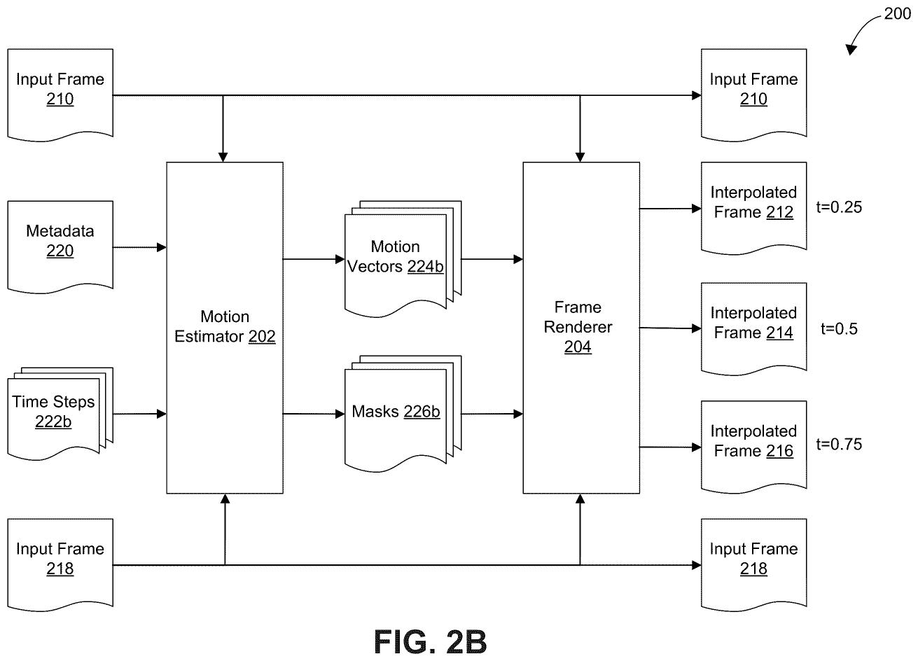

FIG. 2A is a block diagram illustrating a first view of an example system 200 that may generate an interpolated frame 214. In general, a motion estimator 202 may generate motion vectors 224a and a mask 226a based on an input frame 210, an input frame 218, metadata 220, and a time step 222a and a frame renderer 204 may generate an interpolated frame 214 based on input frame 210, input frame 218, motion vectors 224a, and mask 226a.

Input frame 210 and input frame 218 may be two example images of a series of image frames (e.g., of video data). According to the example of FIG. 2A, Input frame 210 precedes input frame 218 in the series of images frames. Input frame 210 and input frame 218 may represent the same scene.

Metadata 220 may be, or may include, metadata that may be used by motion estimator 202. Metadata 220 may include, for example, a depth-map related to input frame 210 and input frame 218, game-engine motion vectors associated with input frame 210 and input frame 218. For instance, a system that captures input frame 210 and input frame 218 may also capture or generate a depth representation of the scene represented by input frame 210 and input frame 218. As another example, a game engine that generated input frame 210 and input frame 218 may also generate motion vectors for objects represented by input frame 210 and input frame 218. Metadata 220 is optional in system 200. For example, in some aspects, motion estimator 202 may generate motion vectors 224a and mask 226a based on input frame 210, input frame 218, and time step 222a without metadata 220.

Time step 222a may be, or may include, instructions regarding the generation of interpolated frame 214. For example, time step 222a may indicate an intermediate time between a first time associated with input frame 210 and a second time associated with input frame 218. For example, in the case of a 2× interpolation, time step 222a may indicate a time midway between the time associated with input frame 210 and the time associated with input frame 218. Using set of image frames 102 of FIG. 1A as an example, to generate interpolated frame 108, time step 222a may indicate t=0.5. In some aspects, time step 222a may be represented by an 8-bit integer, for example, with 0 corresponding to t=0, 63 corresponding to t=0.25, 127 corresponding to t=0.5, 191 corresponding to t=0.75 and 255 corresponding to t=1.0. For example, an integer time-step value may be determined as
IntTimeStep=floor(FloatTimeStep*256);
where FloatTimeStep includes values between 0 and 1; and
IntTimeStep includes integer values between 0 and 255.

In the present disclosure, references to “times of” or “times associated with” image frames may refer to a time at which the image frames were captured, generated, and/or meant to be displayed (relative to one another or a starting time). For example, for frame interpolation for image capture, “times of image frames” may refer to times at which the image frames were captured. For frame interpolation for generating video data, times of image frames may refer to times at which the image frames are to be displayed when the video data is viewed.

Motion estimator 202 may be, or may include, a machine-learning model trained to generate motion vectors and masks based on image frames. Motion estimator 202 may infer motion vectors 224a and mask 226a. Motion estimator 202 may be, or may include, for example, a Real-Time Intermediate Flow Estimation for Video Frame Interpolation model (e.g., as described by “Real-Time Intermediate Flow Estimation for Video Frame Interpolation” by Zhewei Huang, Tianyuan Zhang, Wen Heng, Boxin Shi, and Shuchang Zhou, published European Computer Vision Association 2022, available at https://arxiv.org/pdf/2011.06294). As another example, motion estimator 202 may be, or may include, an intermediate feature refine network (IFRNet) (e.g., as described by “IFRNet: Intermediate Feature Refine Network for Efficient Frame Interpolation” by Lingtong Kong, Boyuan Jiang, Donghao Luo, Wenqing Chu, Xiaoming Huang, Ying Tai, Chengjie Wang, and Jie Yang, available at https://arxiv.org/pdf/2205.14620).

Motion vectors 224a may be, or may include, an indication of differences between input frame 210 and input frame 218. Motion vectors 224a may include vectors indicating how pixels (or blocks of pixels) moved between input frame 210 and input frame 218. For example, input frame 210 may be captured in a scene at a first time. Input frame 218 may be captured in the scene at a second time. An object may have moved in the scene between the first time and the second time. Motion vectors 224a may include one or more vectors representing a relationship between pixels that represent the object in input frame 210 and pixels that represent the object in input frame 218. For example, motion vectors 224a may include a vector representing how, in pixel space, the pixels that represent the object “moved” between the first image and the second image.

In the present disclosure, the term “pixel” may refer to positions within an image frame. The term pixel may, or may not, refer to values (e.g., red, green and blue) values of the pixel. In the present disclosure, the term “block” may refer to a group of pixels or a group of positions within an image frame. A block may or may not be rectangular. In the present disclosure, the terms “pixel” and “block” may be used interchangeably to refer to a position (which may be the size of one or more pixels) of an image frame.

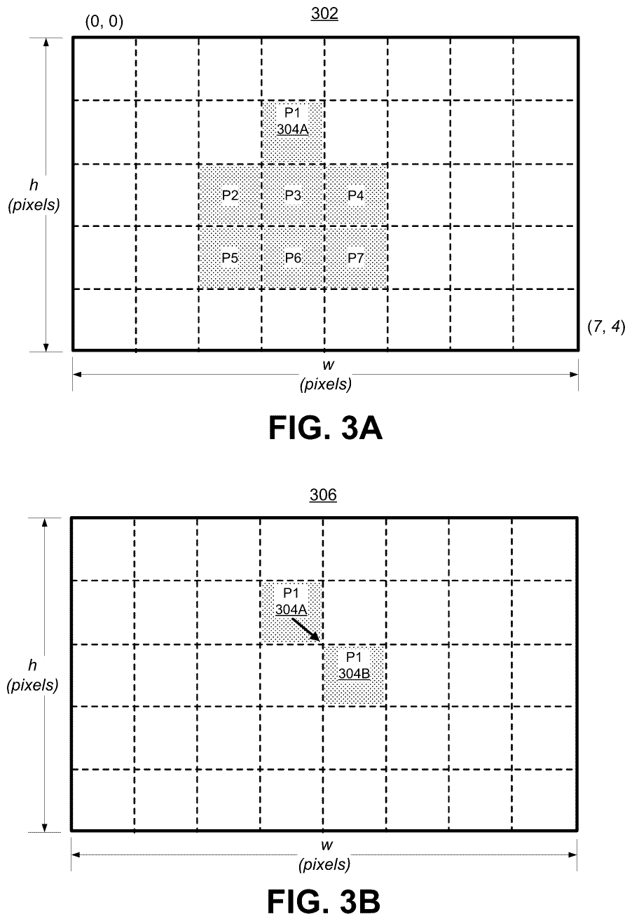

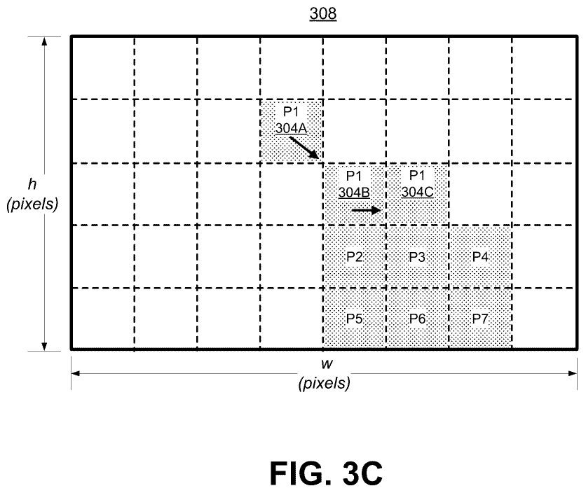

FIG. 3A is a diagram illustrating an example of a frame 302 of a sequence of frames, shown with foreground pixels P1, P2, P3, P4, P5, P6, and P7 (corresponding to an object of interest) at illustrative pixel locations. The other pixels in the frame 302 can be considered background pixels. Frame 302 is shown with dimensions of w pixels wide by h pixels high (denoted as w×h). One of ordinary skill will understand that frame 302 can include many more pixel locations than those illustrated in FIG. 3A. For example, frame 302 can include a 4K (or ultra-high definition (UHD)) frame at a resolution of 3,840×2,160 pixels, an HD frame at a resolution of 1,920×1,080 pixels, or any other suitable frame having another resolution. A pixel P1 is shown at a pixel location 304a. Pixel location 304a can include a (w, h) pixel location of (3, 1) relative to the top-left-most pixel location of (0, 0). The pixel P1 is used for illustrative purposes and can correspond to any suitable point on the object of interest, such as the point of a nose of a person.

FIG. 3B is a diagram illustrating an example of a frame 306 that is adjacent to the frame 302 in the sequence of frames. For instance, frame 306 can occur immediately after frame 302 in the sequence of frames. Frame 306 has the same corresponding pixel locations as that of frame 302 (with dimension w×h). As shown, an object represented by the pixel P1 has moved from pixel location 304a in frame 302 to an updated pixel location 304b in frame 306. In the present disclosure, descriptions of pixels “moving” may refer to objects represented by the pixels moving between frames. The updated pixel location 304b can include a (w, h) pixel location of (4, 2) relative to the top-left-most pixel location of (0, 0). A motion vector can be computed for the pixel P1, indicating the velocity or optical flow of the pixel P1 from frame 302 to frame 306. In one illustrative example, the motion vector for the pixel P1 between the frame 302 and frame 306 is (1, 1), indicating the pixel P1 has moved one pixel location to the right and one pixel location down.

FIG. 3C is a diagram illustrating an example of a frame 308 that is adjacent to frame 306 in the sequence of frames. For instance, frame 308 can occur immediately after frame 306 in the sequence of frames. Frame 308 has the same corresponding pixel locations as that of frame 302 and frame 306 (with dimensions w×h). As shown, the pixel P1 has “moved” from pixel location 304b in frame 306 to an updated pixel location 304c in frame 308. The updated pixel location 304c can include a (w, h) pixel location of (5, 2) relative to the top-left-most pixel location of (0, 0). A motion vector can be computed for the pixel P1 from frame 306 to frame 308. In one illustrative example, the motion vector for the pixel P1 between the frame 306 and frame 308 is (1, 0), indicating the pixel P1 has “moved” one pixel location to the right. The cumulative motion vector for the pixel P1 from frame 302 to frame 308 can be determined as MV_{1,3}=cof(MV_{1,2}, MV_{2,3}). Using the examples from above, the cumulative motion vector MV_{1,3} has an (x, y) value equal to (2, 1) based on the sum of the x- and y-directions of the optical flow vectors—cof((1, 1), (1, 0))=(1+1, 1+0). A similar cumulative motion vector can be determined for all other pixels in the frame 302, frame 306, and frame 308.

Returning to FIG. 2A, motion vectors 224a may include a motion vector for each pixel (or block of pixels) of input frame 210. Each of the motion vectors may indicate how corresponding pixels of input frame 210 “moved” between input frame 210 and input frame 218.

Motion vectors 224a may include forward and backward motion vectors. For example, motion estimator 202 may determine forward motion vectors indicative of how pixels “moved” from input frame 210 to input frame 218. Additionally, motion estimator 202 may determine backward motion vectors indicative of how pixels “moved” from input frame 218 to input frame 210.

Motion estimator 202 may generate motion vectors 224a based on time step 222a. For example, motion estimator 202 may determine forward motion vectors based on how pixels “moved” from input frame 210 to input frame 218 and store the forward motion vectors in association with a point in time based on time step 222a (which is between the time of input frame 210 and the time of input frame 218). Further, motion estimator 202 may determine backward motion vectors based on how pixels “moved” from input frame 218 to input frame 210 and store the backward motion vector in association with a point in time based on time step 222a (which is between the time of input frame 210 and the time of input frame 218).

In some cases, time step 222a may indicate a point in time midway between the times of input frame 210 and input frame 218 (e.g., t=0.5). In such cases, the forward motion vectors and the backward motion vectors may be similar, (e.g., have a similar magnitude and opposite directions). In other cases, time step 222a may be closer to the time of one or the other of input frame 210 and input frame 218. In cases in which time step 222a is closer to the time of input frame 210, the magnitude of the forward motion vectors may be less than the magnitude of the backward motion vectors. In cases in which time step 222a is closer to the time of input frame 218, the magnitude of the forward motion vectors may be greater than the magnitude of the backward motion vectors.

Mask 226a may be, or may include, a mask indicative of differences between input frame 210 and input frame 218. Mask 226a may include blend weights indicative of weights to use to blend input frame 210 and input frame 218 to generate an interpolated image between input frame 210 and input frame 218. For example, to generate an interpolated image, an example mask 226a may include, a blend weight of 0 for a first given pixel to indicate that the first given pixel should be selected 100% from input frame 210. The example mask 226a may also include a blend weight of 0.25 for a second given pixel to indicate that the second given pixel should be blended based on 75% of a corresponding pixels of input frame 210 and 25% of a corresponding pixel of input frame 218. The example mask 226a may also include a blend weight of 0.5 for a third given pixel to indicate that the third given pixel should be blended based on 50% of a corresponding pixels of input frame 210 and 50% of a corresponding pixel of input frame 218. The example mask 226a may also include a blend weight of 0.75 for a fourth given pixel to indicate that the fourth given pixel should be blended based on 25% of a corresponding pixels of input frame 210 and 25% of a corresponding pixel of input frame 218. The example mask 226a may also include a blend weight of 1 for a fifth given pixel to indicate that the fifth given pixel should be selected 100% from input frame 218.

Similar to motion vectors 224a, motion estimator 202 may generate mask 226a based on time step 222a. In cases in which time step 222a is closer to the time of input frame 210, the values of mask 226a may favor input frame 210. In cases in which time step 222a is closer to the time of input frame 218, the values of mask 226a may favor input frame 218.

Additionally, mask 226a may handle occlusions. For example, if a foreground object is moving in front of a background object, mask 226a may cause pixels representing the foreground object to have higher weights for generating interpolated images.

Frame renderer 204 may generate interpolated frame 214 based on input frame 210, input frame 218, motion vectors 224a and mask 226a. For example, frame renderer 204 may select and/or blend pixels of input frame 210 and pixels of input frame 218 based on motion vectors 224a and mask 226a.

Interpolated frame 214 may be an image frame that simulates what a frame between input frame 210 and input frame 218 would look like. For example, input frame 210 and input frame 218 may be captured by a camera or rendered by a video-generation engine. Interpolated frame 214 may simulate what would have been captured or generated at a time between the time of input frame 210 and the time of input frame 218. The time between the time of input frame 210 and the time of input frame 218 may be based on time step 222a.

FIG. 2B is a block diagram illustrating a second view of example system 200 of FIG. 2A. In the example illustrated in FIG. 2A, system 200 generates one interpolated frame (interpolated frame 214) based on time step 222a. In the example illustrated in FIG. 2B, system 200 generates three interpolated frames (interpolated frame 212, interpolated frame 214, and interpolated frame 216) based on three respective time steps 222b.

To perform frame interpolation, conventional techniques may run inference at a motion estimator 202 once for each interpolated frame. For example, to 4× interpolate between input frame 210 and input frame 218, system 200 may use motion estimator 202 to generate a first set of motion vectors 224b and a first mask of masks 226b for a first time of time steps 222b (e.g., t=0.25). System 200 may also use motion estimator 202 to generate a second set of motion vectors 224b and a second mask of masks 226b for a second time of time steps 222b (e.g., t=0.5). Also, system 200 may use motion estimator 202 to generate a third set of motion vectors 224b and a third mask of masks 226b for a third time of time steps 222b (e.g., t=0.75). Frame renderer 204 may generate interpolated frame 212 based on the first set of motion vectors and the first mask, interpolated frame 214 based on the second set of motion vectors and the second mask, and interpolated frame 216 based on the third set of motion vectors and the third mask.

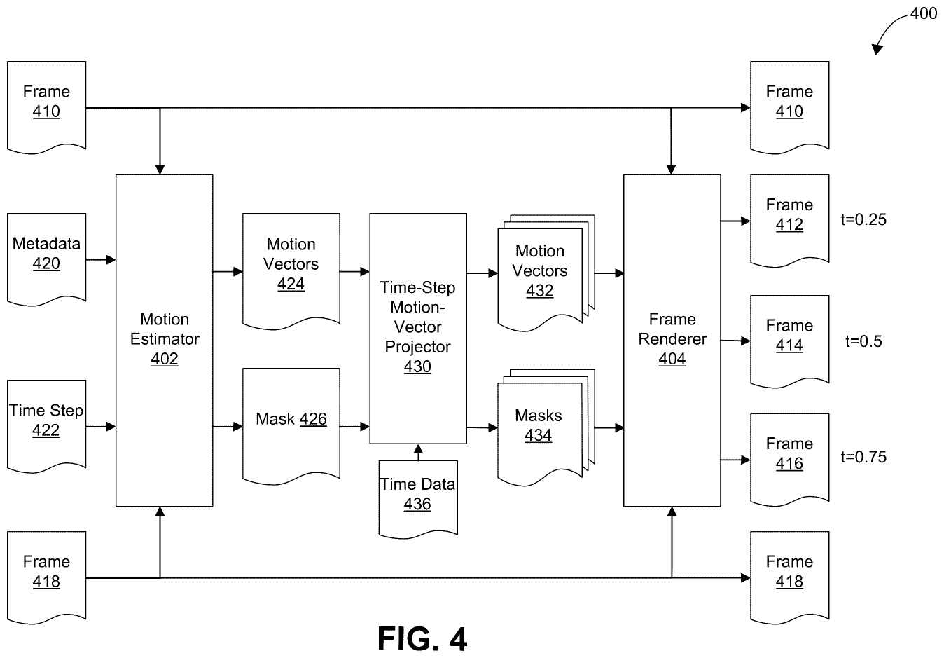

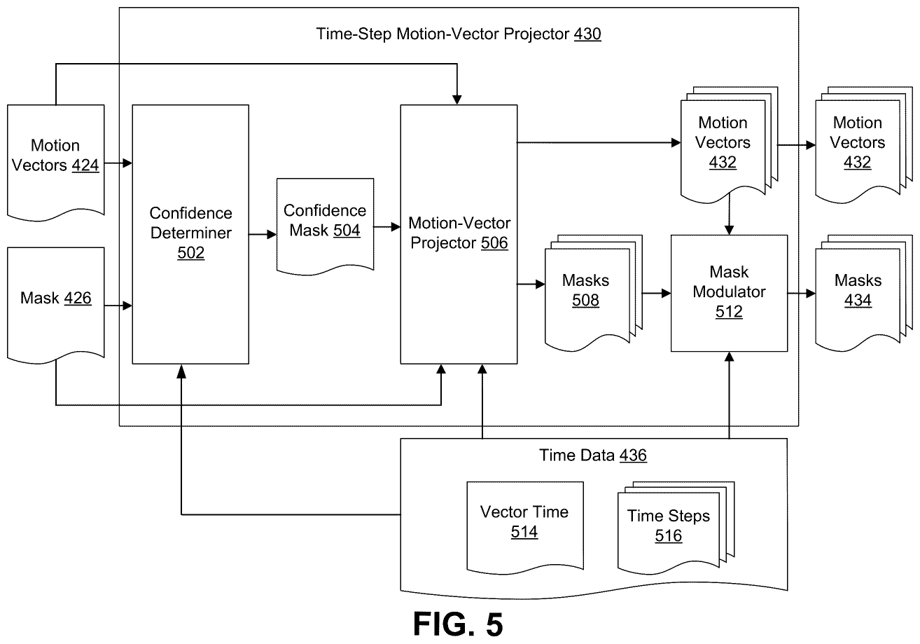

FIG. 4 is a block diagram illustrating an example system 400 that may generate interpolated frames (e.g., frame 412, frame 414, and frame 416), according to various aspects of the present disclosure. For example, system 400 may use a motion estimator 402 to generate motion vectors 424 and a mask 426 based on a frame 410, a frame 418, metadata 420, and time step 422. Next, system 400 may use a time-step motion-vector projector 430 to generate motion vectors 432 and masks 434 based on motion vectors 424, mask 426, and time data 436. A frame renderer 404 of system 400 may generate frame 412 based on one set of motion vectors 432 and one of masks 434, frame 414 based on motion vectors 424 and mask 426, and frame 416 based on another set of 432 and another one of masks 434.

System 200 of FIG. 2A and FIG. 2B may run inference at motion estimator 202 once for each interpolated frame generated. For example, system 200 may use motion estimator 202 to generate a set of motion vectors 224b and a mask of masks 226b for each interpolated image that system 200 will generate.

In contrast, system 400 may run inference at motion estimator 402 once to generate motion vectors 424 and mask 426. Time-step motion-vector projector 430 may project motion vectors 424 and mask 426 to generate any number of sets of motion vectors 432 and masks 434. Frame renderer 404 may generate interpolated frames (e.g., frame 412 and frame 416) based on the projected motion vectors 432 and masks 434. Additionally, in some cases, frame renderer 404 may generate frame 414 based on motion vectors 424 and mask 426. For example, time-step motion-vector projector 430 may provide motion vectors 424 and mask 426 to frame renderer 404. For instance, in some aspects, time-step motion-vector projector 430 may provide motion vectors 424 to frame renderer 404 with motion vectors 432 and provide mask 426 to frame renderer 404 with masks 434.

Motion estimator 402 may be the same as, may be substantially similar to, and/or may perform the same, or substantially the same, operations as motion estimator 202 of FIG. 2A and FIG. 2B. Frame renderer 404 may be the same as, may be substantially similar to, and/or may perform the same, or substantially the same, operations as frame renderer 204 of FIG. 2A and FIG. 2B.

Frame 410 and frame 418 are example input image frames substantially similar to input frame 210 and input frame 218 of FIG. 2A and FIG. 2B. Frame 412, frame 414, and frame 416 are example interpolated image frames substantially similar to interpolated frame 212, interpolated frame 214, and interpolated frame 216 of FIG. 2A and FIG. 2B.

Metadata 420 is example metadata substantially similar to metadata 220 of FIG. 2A and FIG. 2B. Time step 422 are example time steps substantially similar to time step 222a of FIG. 2A. Motion vectors 424 is an example set of motion vectors substantially similar to motion vectors 224a of FIG. 2A. Mask 426 is an example mask substantially similar to mask 226a of FIG. 2A.

Time-step motion-vector projector 430 may generate motion vectors 432 and masks 434 based on motion vectors 424, mask 426, and time data 436. Time-step motion-vector projector 430 may generate forward and backward motion vectors of motion vectors 432. Additional details regarding time-step motion-vector projector 430 are provided with regard to FIG. 5.

Time data 436 may be, or may include, a number of time steps for which time-step motion-vector projector 430 is to generate motion vectors 432 and time data 436. Time data 436 may be based on a frame-interpolation ratio. For example, a frame-interpolation ratio may be four, indicating a 4× frame interpolation, for example, an instruction to generate three frames between two input frames. FIG. 1A illustrates input and interpolated frames of a 4× interpolation. Time data 436 may include time steps t=0.25 and t=0.75 and an instruction generate motion vectors 432 and masks 434 for t=0.25 and t=0.75. Additionally, time data 436 may include an indication of time step 422, which may be the time for which motion estimator 402 generates motion vectors 424 and mask 426. In some cases, time step 422 may be selected to be a time step midway between the time of frame 410 and the time of frame 418 (e.g., t=0.5).

As an example of the power and time saving of system 400 over system 200, motion estimator 202 and motion estimator 402 consume 220 milliwatts (mW) of power and take 13 milliseconds (ms) to run. To perform a 4× interpolation system 200 may run motion estimator 202 three times (once for each of interpolated frame 212, interpolated frame 214, and interpolated frame 216). In doing so, system 200 may consume 660 mW and take 39 ms.

In contrast, time-step motion-vector projector 430 may consume 10 mW and take 1 ms. To perform a 4× interpolation, system 400 may use motion estimator 402 and frame renderer 404 to generate frame 414 and use the time-step motion-vector projector 430 and frame renderer 404 to generate frame 412 and frame 416. In does so, system 400 may consume 240 mW and take 15 ms.

In FIG. 4, system 400 generates frame 412, frame 414, and frame 416 as examples of a 4× interpolation between frame 410 and frame 418. System 400 may generate any number of interpolated frames for any interpolation rate. For example, in some aspects, system 400 may generate one frame between input frames to perform a 2× interpolation, 2.5× interpolation, a 3× interpolation, etc.

As another example, system 400 may generate four frames for every three input frames (e.g., as illustrated and described with regard to FIG. 1B) to perform a 2.5× interpolation. As a first example of performing a 2.5× interpolation, system 400 may take input frame 116 and input frame 122 as inputs (e.g., as examples of frame 410 and frame 418). System 400 may determine time step 422 as t=0.5 and time data 436 as including a time step at t=0.4 (e.g., for interpolated frame 118) and a time step at t=0.8 (e.g., for interpolated frame 120). System 400 may set time step 422 at t=0.5 and use motion estimator 402 to generate motion vectors 424 and mask 426 based on input frame 116 and input frame 122 for t=0.5 (e.g., using input frame 116 as associated with t=0 and input frame 122 as associated with t=1.0). System 400 may set one time step of time data 436 as t=0.4 and use time-step motion-vector projector 430 to generate one set of motion vectors 432 and one of masks 434 for t=0.4 based on motion vectors 424 and mask 426. System 400 may set another time step of time data 436 as t=0.8 and use time-step motion-vector projector 430 to generate another set of motion vectors 432 and another of masks 434 for t=0.8 based on motion vectors 424 and mask 426. Frame renderer 404 may generate interpolated frame 118 based on the one set of motion vectors 432 and one of masks 434 for t=0.4. Additionally, frame renderer 404 may generate interpolated frame 120 based the other set of motion vectors 432 and one of masks 434 for t=0.8.

Further, system 400 may take input frame 122 and input frame 128 as inputs (e.g., as examples of frame 410 and frame 418). System 400 may determine time step 422 at t=1.5 and time data 436 as including a time step at t=1.2 (e.g., for interpolated frame 124) and a time step at t=1.6 (e.g., for interpolated frame 126). System 400 may set time step 422 at t=1.5 and use motion estimator 402 to generate motion vectors 424 and mask 426 based on input frame 122 and input frame 128 for t=1.5 (e.g., using input frame 122 as associated with t=1.0 and input frame 128 as associated with t=2.0). System 400 may set one time step of time data 436 as t=1.2 and use time-step motion-vector projector 430 to generate one set of motion vectors 432 and one of masks 434 for t=1.2 based on motion vectors 424 and mask 426. System 400 may set another time step of time data 436 as t=1.6 and use time-step motion-vector projector 430 to generate another set of motion vectors 432 and another of masks 434 for t=1.6 based on motion vectors 424 and mask 426. Frame renderer 404 may generate interpolated frame 124 based on the one set of motion vectors 432 and one of masks 434 for t=1.2. Additionally, frame renderer 404 may generate interpolated frame 126 based on the other set of motion vectors 432 and the one of masks 434 for t=1.6.

As a second example of performing a 2.5× interpolation, system 400 may take input frame 116 and input frame 122 as inputs (e.g., as examples of frame 410 and frame 418). System 400 may determine time step 422 and time data 436 as including a time step at t=0.4 (e.g., for interpolated frame 118) and a time step at t=0.8 (e.g., for interpolated frame 120). System 400 may set time step 422 at t=0.4 and use motion estimator 402 to generate motion vectors 424 and mask 426 based on input frame 116 and input frame 122 for t=0.4. System 400 may set time data 436 as including t=0.8 and use time-step motion-vector projector 430 to generate motion vectors 432 and one of masks 434 for t=0.8. Frame renderer 404 may generate interpolated frame 118 based on motion vectors 424 and mask 426 and frame renderer 404 may generate interpolated frame 120 based on motion vectors 432 and the one of masks 434.

Further, system 400 may take input frame 122 and input frame 128 as inputs (e.g., as examples of frame 410 and frame 418). System 400 may determine time step 422 and time data 436 as including a time step at t=1.2 (e.g., for interpolated frame 124) and a time step at t=1.6 (e.g., for interpolated frame 126). System 400 may set time step 422 at t=1.6 and use motion estimator 402 to generate motion vectors 424 and mask 426 based on input frame 122 and input frame 128 for t=1.6 (e.g., using input frame 122 as associated with t=1.0 and input frame 128 as associated with t=2.0). System 400 may set time data 436 as including t=1.2 and use time-step motion-vector projector 430 to generate motion vectors 432 and one of masks 434 for t=1.2. Frame renderer 404 may generate interpolated frame 126 based on motion vectors 424 and mask 426 and frame renderer 404 may generate interpolated frame 124 based on motion vectors 432 and the one of masks 434.

FIG. 5 is a block diagram illustrating an example implementation of time-step motion-vector projector 430 of FIG. 4, according to various aspects of the present disclosure. As mentioned previously, time-step motion-vector projector 430 may generate motion vectors 432 and masks 434 based on motion vectors 424, mask 426, and time data 436.

Time data 436 may include vector time 514 and time steps 516. Vector time 514 may reflect a time for which motion vectors 424 and mask 426 are generated. For example, vector time 514 may be an indication of time step 422. Time steps 516 may include time steps for which time-step motion-vector projector 430 is to generate motion vectors 432 and masks 434. Time-step motion-vector projector 430 may generate a respective instance of motion vectors 432 and a respective instance of masks 434 based on each of time steps 516.

A confidence determiner 502 of time-step motion-vector projector 430 may generate a confidence mask 504 based on motion vectors 424, mask 426 and/or time data 436 (e.g., time steps 516). Confidence mask 504 may include a confidence value for each motion vector of motion vectors 424. A confidence value of a given motion vector may indicate a confidence with which Motion-Vector Projector 506 may use the given motion vector.

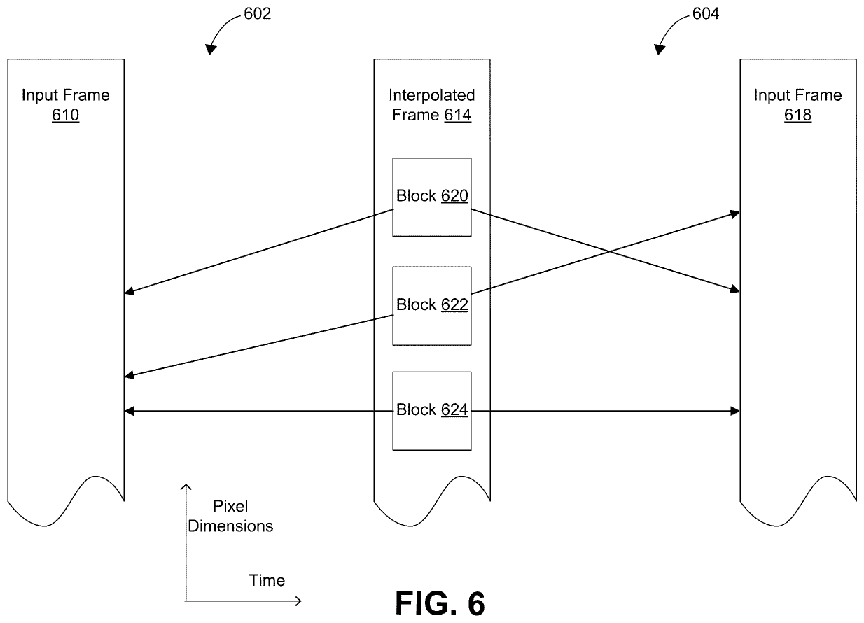

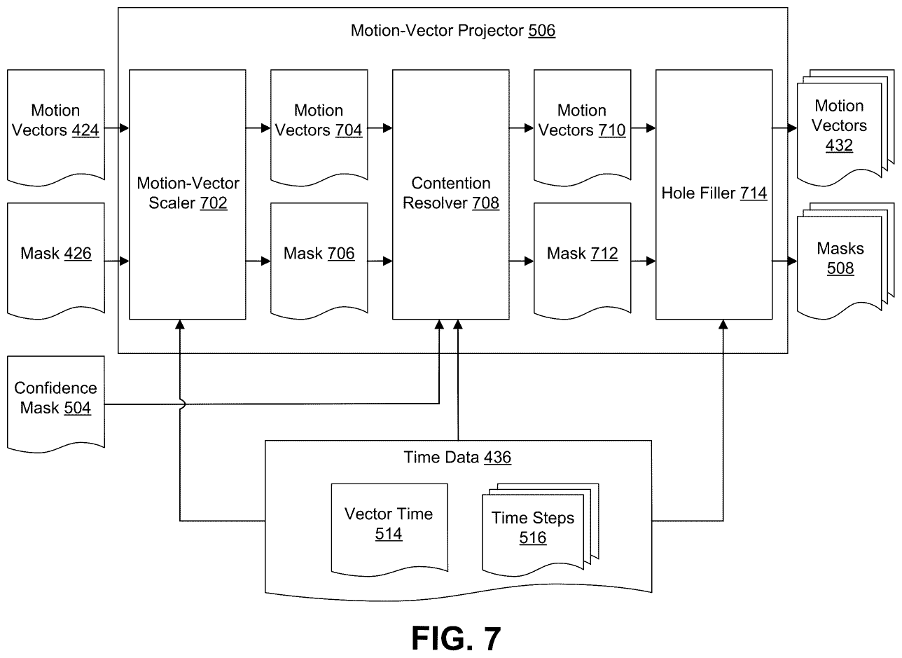

FIG. 6 is a diagram illustrating concepts related to determining confidence values, according to various aspects of the present disclosure. FIG. 6 includes a representation of an input frame 610, a representation of an input frame 618, and a representation of an interpolated frame 614. FIG. 6 further includes a representation of block 620, block 622, and block 624 of interpolated frame 614. Additionally, FIG. 6 includes representations of backward motion vectors 602 and forward motion vectors 604. In FIG. 6, one dimension represents time, and the orthogonal dimension represents pixel dimensions (e.g., x and y) collectively.

Input frame 610 may be an example of an input frame, such as frame 410 of FIG. 4 and input frame 618 may be an example of an input frame, such as frame 418 of FIG. 4. Interpolated frame 614 may be an example of a frame generated based on motion vectors 424 and mask 426 of FIG. 4, such as frame 414 of FIG. 4. In operation, confidence determiner 502 may, or may not, use frame 410, frame 414, or frame 418. FIG. 6 includes representations of input frame 610, interpolated frame 614, and input frame 618 to illustrate concepts related to the operation of confidence determiner 502.

Confidence determiner 502 may operate based on motion vectors 424. Backward motion vectors 602 may be an example of backward motion vectors of motion vectors 424 and forward motion vectors 604 may be an example of forward motion vectors of motion vectors 424. For example, confidence determiner 502 may obtain motion vectors 424, including forward motion vectors indicating changes between an intermediate points in time (based on time step 422) and a first input frame and backward motion vectors indicating changes between the intermediate points in time (based on time step 422) and a second input frame. Confidence determiner 502 may operate on motion vectors 424 (e.g., backward motion vectors 602 and forward motion vectors 604) without using frame 410, frame 414, frame 418 (e.g., input frame 610, interpolated frame 614, and input frame 618).

Confidence determiner 502 may compare forward motion vectors with corresponding backward motion vectors. For example, confidence determiner 502 may compare forward motion vectors that begin at a pixel (or block) position of an image frame (e.g., interpolated frame 614) with backward motion vectors that begin at the pixel (or block). Confidence determiner 502 may determine a confidence for the motion vectors based on the comparison. For example, confidence determiner 502 may determine a confidence score based on a similarity or consistency of forward motion vectors and backward motion vectors.

For example, block 624 may have a backward motion vector that is static and a forward motion vector that is static. For instance the backward motion vector may indicate no change in an X dimension and no change in a Y dimension (e.g., [0,0]) between interpolated frame 614 and input frame 610 and the forward motion vector may indicate no change in an X dimension and no change in a Y dimension (e.g., [0,0]) between interpolated frame 614 and input frame 618. This may be based on pixels that do not change between frame 410 and frame 418. Confidence determiner 502 may determine a high confidence score for block 624 based on the forward motion vector of block 624 being consistent with the backward motion vector of block 624.

Block 622 may have a backward motion vector that has direction and magnitude and a forward motion vector that has a direction and magnitude. For instance the backward motion vector may indicate a change in an X dimension and/or a change in a Y dimension (e.g., [−4,−2]) between interpolated frame 614 and input frame 610 and the forward motion vector may indicate a change in an X dimension and a change in a Y dimension (e.g., [4,2]) between interpolated frame 614 and input frame 618. Confidence determiner 502 may determine a high confidence score for block 622 based on the forward motion vector of block 624 being consistent with the backward motion vector of block 624. For example, backward motion vectors 602 and forward motion vectors 604 may indicate a consistent motion of an object between the time of input frame 610 and the time of input frame 618.

Block 620 may have a backward motion vector that has direction and magnitude and a forward motion vector that has a direction and magnitude. For instance the backward motion vector may indicate a change in an X dimension and/or a change in a Y dimension (e.g., [−2,−4]) between interpolated frame 614 and input frame 610 and the forward motion vector may indicate a change in an X dimension and a change in a Y dimension (e.g., [−4,−2]) between interpolated frame 614 and input frame 618. Confidence determiner 502 may determine a low confidence score for block 620 based on the forward motion vector of block 624 being inconsistent with the backward motion vector of block 624. For example, backward motion vectors 602 and forward motion vectors 604 may indicate inconsistent motion of an object between the time of input frame 610 and the time of input frame 618. Inconsistent motion (especially at frame-rendering and/or frame-capture rates) may be suspect.

As an example, confidence determiner 502 may perform collocated reliable consistency to check if forward (FW) and backward (BW) motion vector (MV) components do not vary too much both in direction and magnitude. For example, confidence determiner 502 may determine:

$$abs ( α ⋆ MVBWx + β ⋆ MVFWx ) + abs ( α ⋆ MVBWy + β ⋆ MVFWy ) \leq thr ;$$

where α represents a scaling used for backward motion vectors (which may be based on a time step, for example as indicated by time steps 516, and/or based on an occlusion mask, for example mask 426);
where β represents a scaling used for forward motion vectors (which may be based on a time step, for example as indicated by time steps 516, and/or based on an occlusion mask, for example mask 426);
where MVBWx is the x component of the backward motion vector;
where MVFWx is the x component of the forward motion vector;
where MVBWy is the y component of the backward motion vector;
where MVFWy is the y component of the forward motion vector;
where thr is linear scaling of original MV magnitude to allow for more variation for larger MVs.

thr could be impacted by linear scaling of original motion vector magnitude and/or mask occlusion information. For example, larger motion vectors and/or occluded blocks in the mask could have higher threshold to allow for more tolerance of differences, making it harder for them to be flagged as unreliable. If the condition is true, confidence determiner 502 may determine the MV to be reliable for FW and BW. If the conditions false, determine the MV to be unreliable. For example, confidence determiner 502 may determine confidence mask 504 as a binary mask including indications of whether each of motion vectors 424 are reliable or unreliable.

The operation of confidence determiner 502 may, or may not, depend on the time step based on which motion vectors 424 were generated. For example, confidence determiner 502 may generate confidence mask 504 based on motion vectors 424 independent of time step 422.

Returning to FIG. 5, a motion-vector projector 506 may generate motion vectors 432 and masks 508 based on motion vectors 424, mask 426, time data 436, and confidence mask 504. Motion-vector projector 506 may project motion vectors 424 to generate intermediate motion vectors (motion vectors 432) representing motion vectors for time steps 516 between frame 410 and frame 418. Similarly, motion-vector projector 506 may project masks 508 to generate intermediate masks (masks 508) representing masks for time steps 516 between frame 410 and frame 418. Motion-vector projector 506 may generate forward and backward motion vectors of motion vectors 432.

FIG. 7 is a block diagram illustrating an example implementation of motion-vector projector 506 of FIG. 5, according to various aspects of the present disclosure. As mentioned above, motion-vector projector 506 may generate motion vectors 432 and masks 508 based on motion vectors 424, mask 426, time data 436, and confidence mask 504. Motion-vector scaler 702 of motion-vector projector 506 may scale and move the motion vectors 424 and mask 426 from an input time step to a new time step. Motion-vector scaler 702 may generate interpolated motion vectors 704 and an interpolated mask 706.

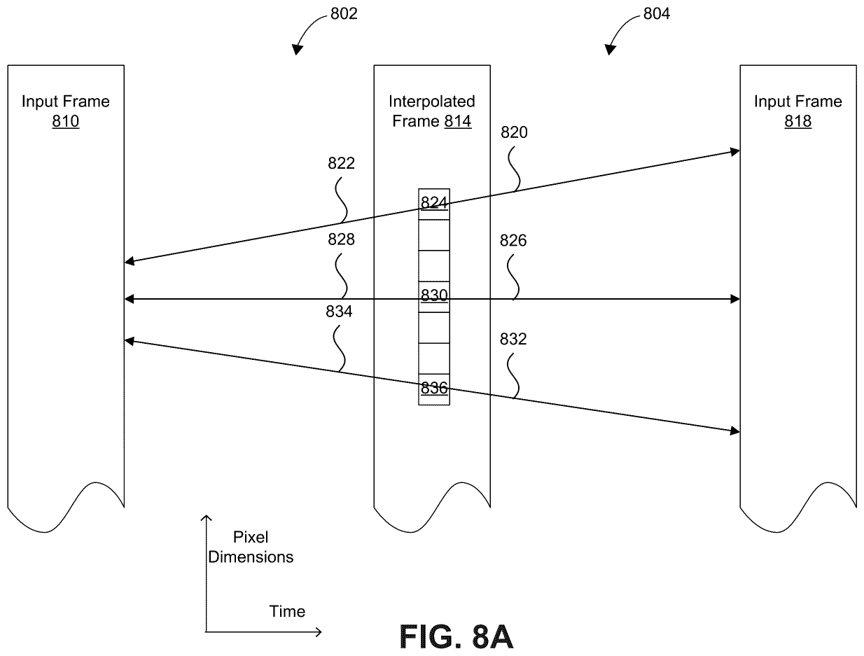

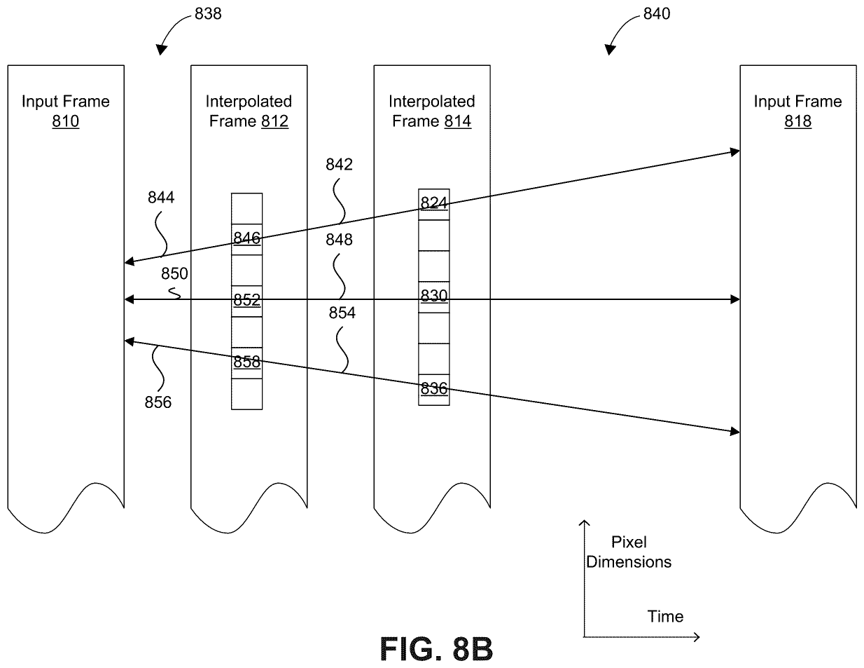

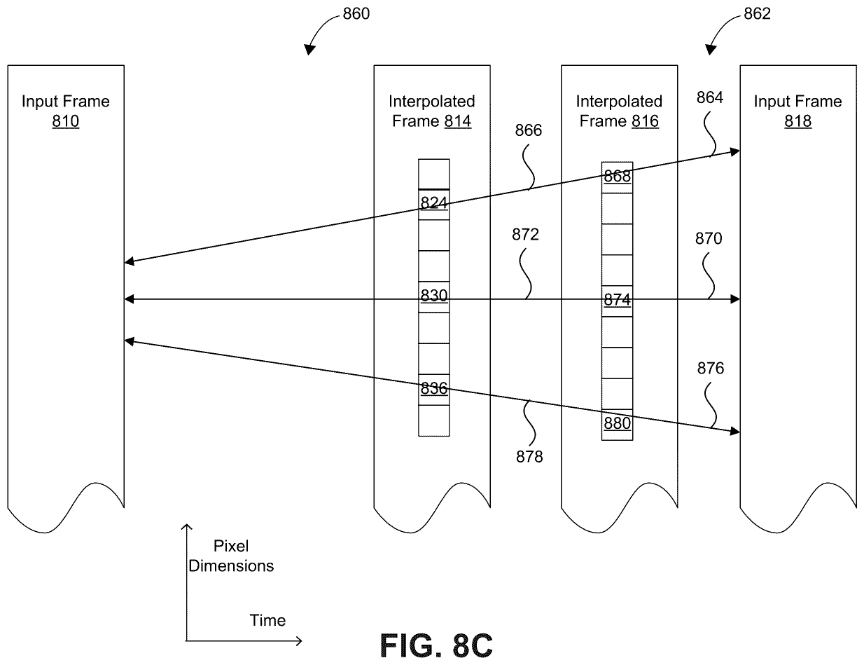

FIG. 8A, FIG. 8B, and FIG. 8C are diagrams illustrating motion vectors and image frames to provide context for a description of concepts related to scaling and/or following motion vectors, according to various aspects of the present disclosure. FIG. 8A includes representations of backward motion vectors 802, forward motion vectors 804, an input frame 810, an input frame 818, and an interpolated frame 814. FIG. 8B includes representations of backward motion vectors 838, forward motion vectors 840, input frame 810, input frame 818, interpolated frame 814, and an interpolated frame 812. FIG. 8C includes representations of backward motion vectors 860, forward motion vectors 862, input frame 810, input frame 818, interpolated frame 814, and an interpolated frame 816. In FIG. 8A, FIG. 8B, and FIG. 8C, one dimension represents time, and the orthogonal dimension represents pixel dimensions (e.g., x and y) collectively.

Input frame 810 may be an example of an input frame, such as frame 410 of FIG. 4 and input frame 818 may be an example of an input frame, such as frame 418 of FIG. 4. Interpolated frame 814 may be an example of a frame generated based on motion vectors 424 and mask 426 of FIG. 4, such as frame 414 of FIG. 4. In operation, motion-vector scaler 702 may, or may not, use frame 410, frame 414, or frame 418. Additionally, motion-vector scaler 702 may not generate frame 412 or frame 416. FIG. 8A, FIG. 8B, and FIG. 8C include representations of input frame 810, interpolated frame 812, interpolated frame 814, interpolated frame 816, and input frame 818 to illustrate concepts related to the operation of motion-vector scaler 702.

Motion-vector scaler 702 may scale motion vectors 424 based on vector time 514 and time steps 516 to generate motion vectors 704. For example, motion vectors 424 may include backward motion vectors (e.g., backward motion vectors 802) between an interpolated frame (e.g., interpolated frame 814) and a first input frame (e.g., input frame 810). Additionally, motion vectors 424 may include forward motion vectors (e.g., forward motion vectors 804) between an interpolated frame (e.g., interpolated frame 814) and a second input frame (e.g., input frame 810). Motion-vector scaler 702 may scale the forward and backward motion vectors based on time steps 516 to generate motion vectors 704. Additionally, motion-vector scaler 702 may update mask 426 to generate mask 706 based on motion vectors 704.

For example, FIG. 8B illustrates an example case in which motion-vector scaler 702 generates backward motion vectors 838 (e.g., backward motion vector 844, backward motion vector 850, and backward motion vector 856) by linearly scaling backward motion vectors 802 (e.g., backward motion vector 822, backward motion vector 828, and backward motion vector 834) based on a time of interpolated frame 812 relative to the time of input frame 810 and the time of interpolated frame 814. Further, motion-vector scaler 702 linearly scales forward motion vectors 804 (e.g., forward motion vector 820, forward motion vector 826, and forward motion vector 832) based on the time of interpolated frame 812 relative to the time of interpolated frame 814 and the time of input frame 818 to generate forward motion vectors 840 (e.g., forward motion vector 842, forward motion vector 848, and forward motion vector 854).

FIG. 8C illustrates an example case in which motion-vector scaler 702 generates backward motion vectors 860 (e.g., backward motion vector 866, backward motion vector 872, and backward motion vector 878) by linearly scaling backward motion vectors 802 (e.g., backward motion vector 822, backward motion vector 828, and backward motion vector 834) based on a time of interpolated frame 816 relative to the time of input frame 810 and the time of interpolated frame 814. Further, motion-vector scaler 702 linearly scales forward motion vectors 804 (e.g, forward motion vector 820, forward motion vector 826, and forward motion vector 832) based on the time of interpolated frame 816 relative to the time of interpolated frame 814 and the time of input frame 818 to generate forward motion vectors 862 (e.g., forward motion vector 864, forward motion vector 870, and forward motion vector 876).

Linearly scaling a vector may include multiplying the vector by a factor. For example, a motion vector may be [8,12]. Scaling the vector by a factor of 0.5 (for example to generate an intermediate motion vector) may include multiplying the motion vector by the factor (e.g., [8,12]*0.5=[4,6]). For example, motion-vector scaler 702 may scale motion vectors for a given time step by a factor based on

$$\frac{abs ( t - t v e c t o r )}{256}$$

where t represents the given time step; and
where t_{vector} represents the time step that the motion estimator ran to generate an interpolated frame.

In addition to scaling the motion vectors, motion-vector scaler 702 may store the motion vectors in association with different blocks in interpolated motion vectors. For example, initially, for example, as illustrated by FIG. 8A, a forward motion vector 820 and a backward motion vector 822 may be stored in association with a block 824 of interpolated frame 814. Motion-vector scaler 702 may not have interpolated frame 814. For example, motion-vector scaler 702 may not have pixel values for interpolated frame 814. Yet, motion-vector scaler 702 may store motion vectors (e.g., backward motion vectors 802 and forward motion vectors 804) in association with blocks (e.g., pixel locations) of an image frame. For example, a forward motion vector 820 and a backward motion vector 822 may be stored in association with block 824. Similarly, a forward motion vector 826 and a backward motion vector 828 may be stored in association with a block 830 and a forward motion vector 832 and a backward motion vector 834 may be stored in association with a block 824.

As part of scaling, motion-vector scaler 702 may update an association between scaled motion vectors and blocks. For example, as illustrated in FIG. 8B, when storing the motion vectors based on the time step of interpolated frame 812, motion-vector scaler 702 may store backward motion vectors 838 and forward motion vectors 840 in association with blocks of interpolated frame 812. Similarly, as illustrated in FIG. 8C, when storing motion vectors based on the time step of interpolated frame 816, motion-vector scaler 702 may store backward motion vectors 860 and forward motion vectors 862 in association with blocks of interpolated frame 816.

Motion-vector scaler 702 may store motion vectors in association with blocks even if the images of the blocks have not yet been generated. For example, at motion-vector scaler 702, there may not be an interpolated frame 812 or an interpolated frame 816. Nevertheless, motion-vector scaler 702 may store backward motion vectors 838 and forward motion vectors 840 in association with pixel (or block) locations within an image frame. For example, motion-vector scaler 702 may store backward motion vectors 838 and forward motion vectors 840 in relation to pixel coordinates, even if there are no pixel values (e.g., red, green, blue values) associated with the pixel coordinates.

For example, as illustrated in FIG. 8B, motion-vector scaler 702 may store forward motion vector 842 and backward motion vector 844 in association with block 846, forward motion vector 848 and backward motion vector 850 in association with block 852, and forward motion vector 854 and backward motion vector 856 in association with block 858. As illustrated in FIG. 8B, block 846, block 852, and block 858 may, or may not be the same in pixel coordinates as block 824, block 830, and block 836.

As another example, as illustrated in FIG. 8C, motion-vector scaler 702 may store forward motion vector 864 and backward motion vector 866 in association with block 868, forward motion vector 870 and backward motion vector 872 in association with block 874, and forward motion vector 876 and backward motion vector 878 in association with block 880. As illustrated in FIG. 8C block 868, block 874, and block 880 may, or may not be the same in pixel coordinates as block 824, block 830, and block 836.

In the present disclosure, storing a motion vector (or other value) in association with a block based on the motion vector and a time step may be referred to as “following” the motion vector. For example, motion-vector scaler 702 may scale backward motion vector 822 and forward motion vector 820 based on input frame 810, interpolated frame 812, interpolated frame 814, and input frame 818 to determine a magnitude of backward motion vector 844 and forward motion vector 842. Additionally, motion-vector scaler 702 may follow backward motion vector 844 and forward motion vector 842 to determine an association between backward motion vector 844 and forward motion vector 842 and block 846.

Returning to FIG. 7, motion-vector scaler 702 may scale and follow motion vectors 424 from an input time step to a new time step (e.g., based on time data 436) to generate motion vectors 704. In addition to scaling and following motion vectors 424, motion-vector scaler 702 may also update the “positions” of mask values of mask 426 to generate mask 706. For example, mask 426 may include values arranged in a grid that may correspond to pixels (or blocks) of image frames. Motion-vector scaler 702 may update the positions of mask values of mask 426 to generate mask 706 based on how associations between motion vectors and blocks changed. For example, motion-vector scaler 702 may cause mask values to follow vector changes. For example, motion-vector scaler 702 may update a position of a mask value to mirror a change to an association between a corresponding motion vector and blocks of an image frame.

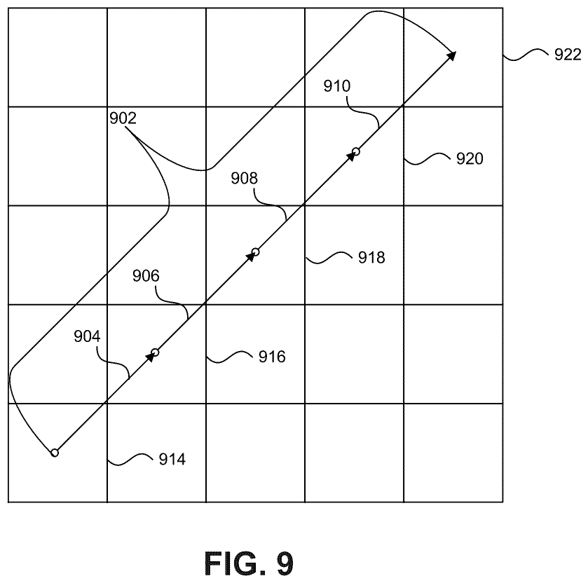

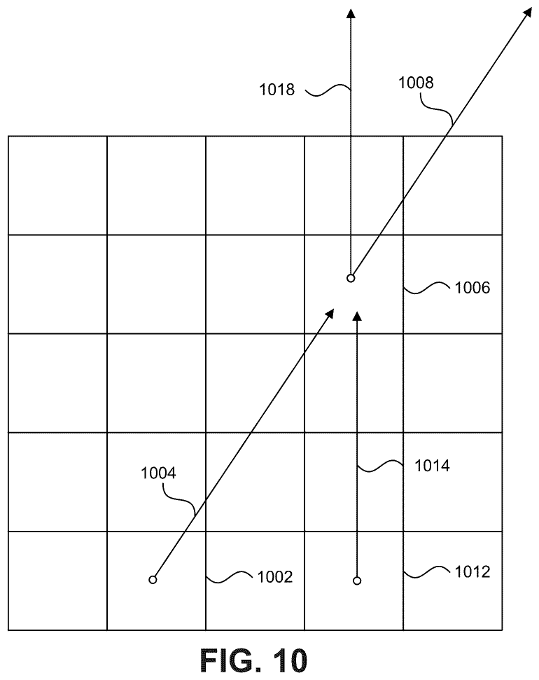

FIG. 9 and FIG. 10 are diagrams illustrating blocks in an image frame and motion vectors in relation to the blocks to provide context for a description of concepts related to following motion vectors according to various aspects of the present disclosure. For example, FIG. 9 includes a motion vector 902 that has an origin in block 914 and x and y components [4,4](e.g., four blocks to the right and four blocks up). Motion-vector scaler 702 may scale motion vector 902 to generate four scaled motion vectors (e.g., scaled motion vector 904, scaled motion vector 906, scaled motion vector 908, and scaled motion vector 910) for four time steps. Each of the scaled motion vectors may have a magnitude that is one quarter of the magnitude of motion vector 902. For example, each of scaled motion vector 904, scaled motion vector 906, scaled motion vector 908, and scaled motion vector 910 may have x and y components [1,1](e.g., one block to the right and one block up). Motion-vector scaler 702 may determine an association between blocks and motion vectors. For example, motion-vector scaler 702 may determine an origin for each of the scaled motion vectors and associate the scaled motion vectors with the blocks for their respective time steps. For example, scaled motion vector 904 may be associated with block 916 for a first time step. Motion-vector scaler 702 may associate scaled motion vector 906 with block 918 for a second time step, scaled motion vector 908 with block 920 for a third time step, and scaled motion vector 910 with block 922 for a fourth time step.

Although not illustrated in FIG. 9, motion-vector scaler 702 may store mask values of mask 426 with updated associations in mask 706 to mirror the updating of associations of the scaled motion vectors. For example, mask 426 may store a mask value for each of block 916, block 918, block 920, and block 922. Motion-vector scaler 702 may store the initial mask value of block 914 associated with block 916 for an interpolated mask of a first time step, the initial mask value of block 914 associated with block 918 for an interpolated mask of a second time step, the initial mask value of block 914 associated with block 920 for an interpolated mask of a third time step and the initial mask value of block 914 associated with block 922 for an interpolated mask of a fourth time step.

Following motion vectors (for both scaled motion vectors and mask values) may cause gaps and/or contentions. For example, FIG. 10 includes a scaled motion vector 1004 having an origin at block 1002 and x and y components [2,3] and a scaled motion vector 1008 having an origin at block 1006 and x and y components [2,3]. Scaled motion vector 1004 and scaled motion vector 1008 are scaled portions of the same motion vector originating from block 1002. Additionally, FIG. 10 includes a scaled motion vector 1014 having an origin at block 1012 and x and y components [0,3] and a scaled motion vector 1018 having an origin at block 1006 and x and y components [0,3]. Scaled motion vector 1014 and scaled motion vector 1018 are scaled portions of the same motion vector originating from block 1012.

Scaled motion vector 1004 and scaled motion vector 1014 may both end at block 1006. It may be desirable to store only one scaled motion vector in association with each block of an image frame for a time step. As such, scaled motion vector 1004 and scaled motion vector 1014 may be in contention for block 1006.

Returning to FIG. 7, a contention resolver 708 of motion-vector projector 506 may resolve contentions (which may alternatively be referred to as “conflicts”) between motion vectors (and/or mask values). Contention resolver 708 may resolve contentions based on confidence mask 504, for example, by determining which motion vectors to associate with which blocks based on confidence values associated with the motion vectors. As described above, confidence mask 504 may be an indication of a confidence with which motion-vector projector 506 may use motion vectors 424. For example, contention resolver 708 may associate higher-confidence motion vectors with blocks. In cases in which two motion vectors are in contention for a block and both are associated with the same confidence value (including cases in which confidence mask 504 is a binary mask), contention resolver 708 may determine which motion vector to associate with the block based on the lengths of the contending motion vectors. Contention resolver 708 may generate motion vectors 710 and mask 712 by resolving contentions in motion vectors 704 and mask 706.

Returning to FIG. 10 as an example, contention resolver 708 may resolve a contention between scaled motion vector 1004 and scaled motion vector 1014 for block 1006 based on confidence mask 504. For example, contention resolver 708 may select the one of scaled motion vector 1004 and scaled motion vector 1014 that is associated with a higher confidence value in confidence mask 504 and associate the selected one of scaled motion vector 1004 and scaled motion vector 1014 with block 1006. Scaled motion vector 1004 and scaled motion vector 1008 may be associated with a confidence value based on a vector from which scaled motion vector 1004 and scaled motion vector 1008 were scaled. Similarly, scaled motion vector 1014 and scaled motion vector 1018 may be associated with a confidence value based on a vector from which scaled motion vector 1014 and scaled motion vector 1018 were scaled.

In cases in which scaled motion vector 1004 and scaled motion vector 1014 are associated confidence values that are the same (including cases in which confidence mask 504 is a binary mask indicating that both scaled motion vector 1004 and scaled motion vector 1014 are reliable), contention resolver 708 may select a scaled motion vector based on length. For example, contention resolver 708 may select the shorter of scaled motion vector 1004 or scaled motion vector 1014.

Returning to FIG. 7, contention resolver 708 may determine associations for motion vectors and mask values based on confidence mask 504 and motion vectors 704. Contention resolver 708 may resolve contentions in motion vectors 704 and mask 706 to generate motion vectors 710 and mask 712 without contentions. Hole filler 714 may fill holes in motion vectors 710 and mask 712 to generate motion vectors 432 and masks 508. Motion-vector scaler 702, contention resolver 708, and hole filler 714 may operate on forward and backward motion vectors. For example, motion vectors 704, motion vectors 710, and motion vectors 432 may include both forward and backward motion vectors.

Returning to FIG. 10, following motion vectors to update associations may leave some blocks without motion vectors and/or mask values. For example, for a time step, scaled motion vector 1008 may be stored in association with block 1006. In some cases, there may be no motion vector associated with block 1002 for the time step. A block that does not have a motion vector and/or mask association may be referred to, in the present disclosure, as a “hole.” Hole filler 714 may fill holes in motion vectors 710 and mask 712. Hole filler 714 may select an association of a prior time step to fill holes. For example, hole filler 714 may select an association from the time step that the motion estimator ran to fill holes. For example, in cases in which block 1002 is left without an association, hole filler 714 may generate a prior instance of motion vector originating from block 1002. Similarly, hole filler 714 may generate a prior instance of a mask value of block 1002 to be associated with block 1002 for the time step. For example, hole filler 714 may select an association from the time step that the motion estimator ran to fill holes.

Returning to FIG. 5, motion-vector projector 506 may generate motion vectors 432 and masks 508 (e.g., as described with regard to the example implementation described with regard to FIG. 7). Additionally, a mask modulator 512 may generate masks 434 based on masks 508 and motion vectors 432. Motion-vector projector 506 may cause mask values to change “position” within the mask (by following motion vectors), yet the values may remain the same. Mask modulator 512 may change the values of masks 508 to generate masks 434.

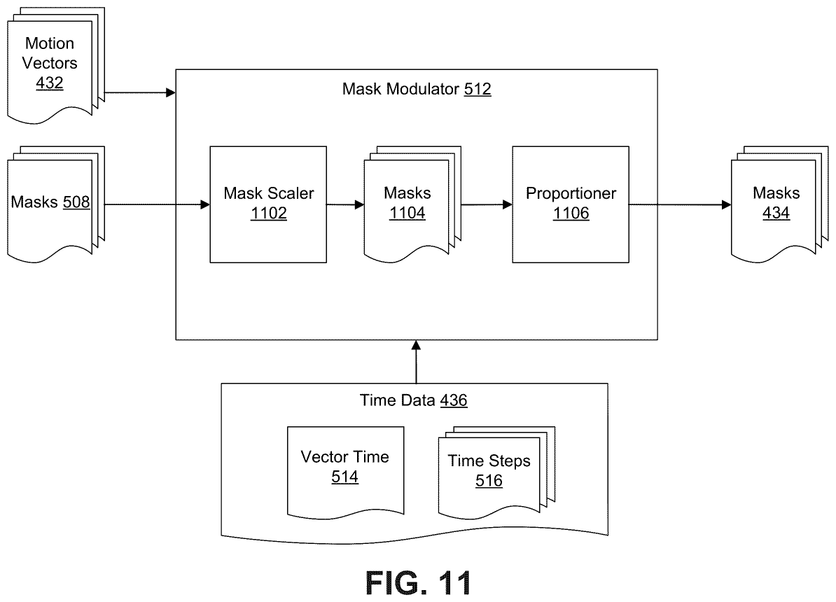

FIG. 11 includes an example implementation of mask modulator 512 of FIG. 5, according to various aspects of the present disclosure. A mask scaler 1102 of mask modulator 512 may, for each block in masks 508, linearly scale the mask value in the correct direction. The scaling for a given time step may be based on
ScaledBWWeight=OriginalBWWeight*((TimeStepSize−t)/TimeStepSize); and
ScaledFWWeight=OriginalFWWeight*(t/TimeStepSize)
where ScaledBWWeight represents the backward weights of masks after scaling;
where OriginalBWWeight represents the original backward weights of masks;
where ScaledFWWeight represents the forward weights of masks after scaling;
where OriginalFWWeight represents the original forward weights of masks;
where t represents the given time step.

where TimeStepSize represents the max size of a time step between two input frames. Mask scaler 1102 may determine and apply scaling to mask values for both forward and backward mask values. For example, masks 508 and masks 1104 may include forward mask values and backward mask values.

Proportioner 1106 may roughly maintain proportion of weights (forward to backward) from the initial weights to the final weights. For example, proportioner 1106 may cause masks 434 to have roughly the same proportion of backward weights to forward weights as masks 508. For example, proportioner 1106 may apply:

$$\frac{ScaledBWWeight}{ScaledFWWeight} = \frac{NewBWWeight}{TimeStepSize - NewBWWeight}$$

$$and$$

$$NewFWWeight = TimeStepSize - NewBWWeight$$

where ScaledBWWeight represents the scaled backward weights of masks 1104;
where ScaledFWWeight represents the scaled forward weights of masks 1104;
where NewBWWeight represents backward weights of masks 434; and
where NewFWWeight represents forward weights of masks 434.

where TimeStepSize represents the max size of a time step between two input frames. In some aspects, when modulating mask weights of motion vectors, mask modulator 512 may put more weight on the motion vector which is ‘closer’ in time to an original frame, which may help create less artifacts during interpolation. For example, in 4× interpolation, mask modulator 512 may use forward motion vectors for the first interpolated frame (e.g., interpolated frame 812) and use backward motion vectors for the third interpolated frame (e.g., interpolated frame 816). In some aspects, mask modulator 512 may use forward and backward motion vectors equally for the second interpolated frame (e.g., interpolated frame 814). For example, mask modulator 512 may adjust some of the weights and that could result in using forward and backward motion vectors equally.

For example, interpolated frame 812 may be closer to input frame 810 so forward motion vectors may be used to warp input frame 810 during interpolation. Interpolated frame 816 may be closer to input frame 818 and backward motion vectors may be used to warp input frame 818 during interpolation.

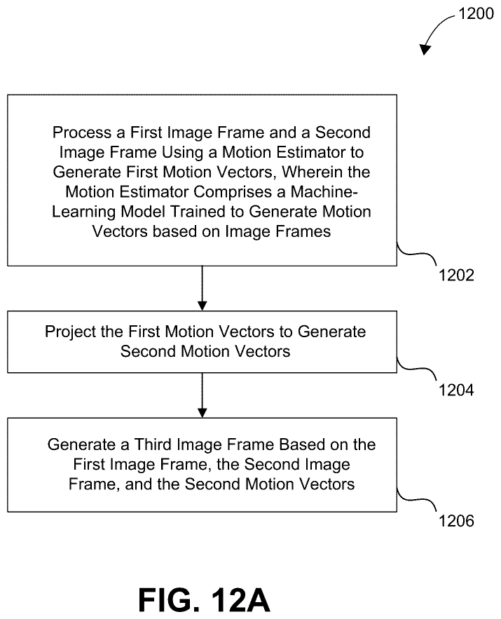

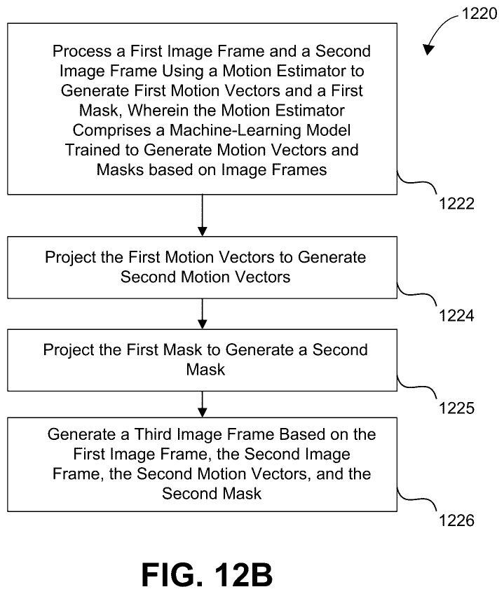

FIG. 12A is a flow diagram illustrating an example process 1200 for generating interpolated image frames, in accordance with aspects of the present disclosure. One or more operations of process 1200 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1200. The one or more operations of process 1200 may be implemented as software components that are executed and run on one or more processors.

At block 1202, a computing device (or one or more components thereof) may process a first image frame and a second image frame using a motion estimator to generate first motion vectors. The motion estimator may be, or may include, a machine-learning model trained to generate motion vectors based on image frames. For example, motion estimator 402 may process frame 410 and frame 418 to generate motion vectors 424. Motion estimator 402 may be, or may include, a machine-learning model trained to generate motion vectors based on image frames.

In some aspects, the first motion vectors may be generated based on a time step between a first time associated with the first image frame and a second time associated with the second image frame. For example, motion estimator 402 may generate motion vectors 424 based on a time step between a time of frame 410 and a time of frame 418.

In some aspects, the computing device (or one or more components thereof) may process the first image frame and the second image frame using the motion estimator to generate a first mask. For example, motion estimator 402 may process frame 410 and frame 418 to generate mask 426.

At block 1204, the computing device (or one or more components thereof) may project the first motion vectors to generate second motion vectors. For example, time-step motion-vector projector 430 may project motion vectors 424 to generate motion vectors 432.

In some aspects, the first motion vectors may be projected based on a frame-interpolation ratio based on an input frame rate and an output frame rate. For example, time-step motion-vector projector 430 may project motion vectors 432 based on a frame-interpolation ratio based on an input frame rate and an output frame rate (e.g., a desired output frame rate).

In some aspects, to project the first motion vectors, the computing device (or one or more components thereof) may linearly scale the first motion vectors based on the frame-interpolation ratio to generate scaled motion vectors. For example, time-step motion-vector projector 430 may linearly scale motion vectors 424 based on a frame-interpolation ratio to generate motion vectors 432.

In some aspects, to project the first motion vectors, the computing device (or one or more components thereof) may update associations between the scaled motion vectors and pixel positions. For example, time-step motion-vector projector 430 may update associations between motion vectors and pixel positions (e.g., as described with regard to FIG. 8, FIG. 9, and FIG. 10).

In some aspects, to project the first motion vectors, the computing device (or one or more components thereof) may resolve gaps in the associations between the scaled motion vectors and the pixel positions. For example, hole filler 714 of time-step motion-vector projector 430 may resolve gaps in associations between motion vectors and pixel positions (e.g., as described with regard to FIG. 10).

In some aspects, to resolve gaps in the associations between the scaled motion vectors and the pixel positions, the computing device (or one or more components thereof) may fill the gaps with prior first motion vectors. For example, hole filler 714 of time-step motion-vector projector 430 may fill gaps in associations between motion vectors and pixel positions with prior first motion vectors (e.g., as described with regard to FIG. 10). For example, hole filler 714 may select an association from the time step that the motion estimator ran to fill holes.

In some aspects, the computing device (or one or more components thereof) may resolve conflicts in the associations between the scaled motion vectors and the pixel positions. For example, contention resolver 708 of time-step motion-vector projector 430 may fill resolve conflicts in the associations between the scaled motion vectors and the pixel positions (e.g., as described with regard to FIG. 10).

In some aspects, the computing device (or one or more components thereof) may generate a confidence mask based on the first motion vectors, wherein the conflicts are resolved based on the confidence mask. For example, confidence determiner 502 of time-step motion-vector projector 430 may determine confidence mask 504 and contention resolver 708 may resolve conflicts based on confidence mask 504.

In some aspects, the conflicts are resolved by selecting a scaled motion vector associated with a higher confidence value in the confidence mask over a scaled motion vector associated with a lower confidence value in the confidence mask. For example, contention resolver 708 may select motion vectors associated with higher confidence values over motion vectors associated with lower confidence values.

In some aspects, to generate the confidence mask, the computing device (or one or more components thereof) may: determine first-to-second motion vectors based on the first image frame and the second image frame; determine second-to-first motion vectors based on the second image frame and the first image frame; and compare the first-to-second motion vectors to the second-to-first motion vectors. For example, confidence determiner 502 may determine backward motion vectors 602 and forward motion vectors 604 and determine confidence mask 504 based on backward motion vectors 602 and forward motion vectors 604 (e.g., as described with regard to FIG. 6).

In some aspects, the conflicts may be resolved based on lengths of conflicting scaled motion vectors. For example, contention resolver 708 may resolve conflicts based on lengths of motion vectors, for example, choosing a shorter motion vector over a longer motion vector (e.g., as described with regard to FIG. 10).

In some aspects, the computing device (or one or more components thereof) may project the first mask to generate a second mask. For example, time-step motion-vector projector 430 may project mask 426 to generate masks 434.

In some aspects, to project the first mask, the computing device (or one or more components thereof) may update mask values of the first mask based on the updated associations between the scaled motion vectors and the pixel positions. For example, the computing device (or one or more components thereof) may first follow the process of projecting the first motion vectors (e.g., at block 1204). Once the process is completed for motion vectors, the resulting pixel associations of the projected motion vectors (e.g., the second motion vectors) have been updated. The mask may also be updated to have the same pixel associations (e.g., without repeating the process for the masks). For example, the masks may use the updated motion-vector associations without redetermining how to scale the mask. A difference is that the mask weights may not have their pixel associations updated to be the same if it is an occluded area (occluded areas will be areas that have a specific range of values for the mask weights).

In some aspects, the computing device (or one or more components thereof) may process the first image frame and the second image frame using the motion estimator to generate a first mask; and project the first mask to generate a second mask. To project the first mask, the computing device (or one or more components thereof) may update mask values of the first mask based on the updated associations between the scaled motion vectors and the pixel positions. The third image frame may be generated further based on the second mask.

At block 1206, the computing device (or one or more components thereof) may generate a third image frame based on the first image frame, the second image frame, and the second motion vectors. For example, frame renderer 404 may generate frame 412 based on frame 410, frame 418, and motion vectors 432.

In some aspects, the second motion vectors may be, or may include, backward motion vectors suggestive of differences between pixels of the third image frame and pixels of the first image frame and forward motion vectors suggestive of differences between pixels of the third image frame and the pixels of the second image frame. For example, motion vectors 432 may include forward motion vectors that suggest differences between frame 410 and frame 412 and backward motion vectors that suggest differences between frame 412 and frame 418. Motion vectors 432 may be generated before frame 412 is generated and frame 412 may be generated based, at least in part, on motion vectors 432. As such, motion vectors 432 may suggest differences between frame 410 and frame 412 and between frame 412 and frame 418. Frame renderer 404 may generate frame 412 based on such differences.

In some aspects, the computing device (or one or more components thereof) may generate a fourth image frame based on the first image frame, the second image frame, and the first motion vectors. For example, frame renderer 404 may generate frame 414 based on frame 410, frame 418, and motion vectors 424.

In some aspects, the first motion vectors may be, or may include, backward motion vectors suggestive of differences between pixels of the fourth image frame and pixels of the first image frame and forward motion vectors suggestive of differences between pixels of the fourth image frame and pixels of the second image frame. For example, motion vectors 424 may include forward motion vectors that suggest differences between frame 410 and frame 414 and backward motion vectors that suggest differences between frame 414 and frame 418. Motion vectors 424 may be generated before frame 414 is generated and frame 414 may be generated based, at least in part, on motion vectors 424. As such, motion vectors 424 may suggest differences between frame 410 and frame 414 and between frame 414 and frame 418. Frame renderer 404 may generate frame 414 based on such differences.

In some aspects, the computing device (or one or more components thereof) may process the first image frame and the second image frame using the motion estimator to generate a first mask; and project the first mask to generate a second mask; wherein the third image frame is generated further based on the second mask. For example, motion estimator 402 may generate mask 426, time-step motion-vector projector 430 may project mask 426 to generate masks 434, and frame renderer 404 may generate frame 412 based, at least in part, on masks 434.

In some aspects, the computing device (or one or more components thereof) may, when projecting the first mask, exclude from updating mask values that are within a threshold range, wherein the threshold range is indicative of occlusion in at least one of the first image frame or the second image frame. For example, the computing device (or one or more components thereof) may first follow the process of projecting the first motion vectors (e.g., at block 1204). Once the process is completed for motion vectors, the resulting pixel associations of the projected motion vectors (e.g., the second motion vectors) have been updated. The mask may also be updated to have the same pixel associations (e.g., without repeating the process for the masks). For example, the masks may use the updated motion-vector associations without redetermining how to scale the mask. A difference is that the mask weights may not have their pixel associations updated to be the same if it is an occluded area (occluded areas will be areas that have a specific range of values for the mask weights).

In some aspects, the computing device (or one or more components thereof) may modulate the second mask. For example, mask modulator 512 may modulate masks 434.

In some aspects, the computing device (or one or more components thereof) may linearly scale values of the first mask based on a time step between a first time associated with the first image frame and a second time associated with the second image frame to generate the second mask.

In some aspects, the computing device (or one or more components thereof) may scale the values of the second mask based on values of the first mask. For example, the computing device (or one or more components thereof) may roughly maintain the proportion of the first mask values in the resulting second mask values by applying a global scale to the scaled mask values.

FIG. 12B is a flow diagram illustrating an example process 1220 for generating interpolated image frames, in accordance with aspects of the present disclosure. One or more operations of process 1220 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1220. The one or more operations of process 1220 may be implemented as software components that are executed and run on one or more processors.

At block 1222, a computing device (or one or more components thereof) may process a first image frame and a second image frame using a motion estimator to generate first motion vectors and a first mask. The motion estimator may be, or may include, a machine-learning model trained to generate motion vectors and masks based on image frames. For example, motion estimator 402 may process frame 410 and frame 418 to generate motion vectors 424 and mask 426. Motion estimator 402 may be, or may include, a machine-learning model trained to generate motion vectors and masks based on image frames.

At block 1224, the computing device (or one or more components thereof) may project the first motion vectors to generate second motion vectors. For example, time-step motion-vector projector 430 may project motion vectors 424 to generate motion vectors 432.

At block 1225, the computing device (or one or more components thereof) may project the first mask to generate a second mask. For example, time-step motion-vector projector 430 may mask 426 to generate masks 434.

In some aspects, to project the first mask, the computing device (or one or more components thereof) may update mask values of the first mask based on the updated associations between the scaled motion vectors and the pixel positions. For example, the computing device (or one or more components thereof) may first follow the process of projecting the first motion vectors (e.g., at block 1204). Once the process is completed for motion vectors, the resulting pixel associations that the projected motion vectors (e.g., the second motion vectors) have been updated. The mask may also be updated to have the same pixel associations (e.g., without repeating the process for the masks). For example, the masks may use the updated motion-vector associations without redetermining how to scale the mask. A difference is that the mask weights may not have their pixel associations updated to be the same if it is an occluded area (occluded areas will be areas that have a specific range of values for the mask weights).

At block 1226, the computing device (or one or more components thereof) may generate a third image frame based on the first image frame, the second image frame, the second motion vectors, and the second mask. For example, frame renderer 404 may generate frame 412 based on frame 410, frame 418, motion vectors 432, and masks 434.

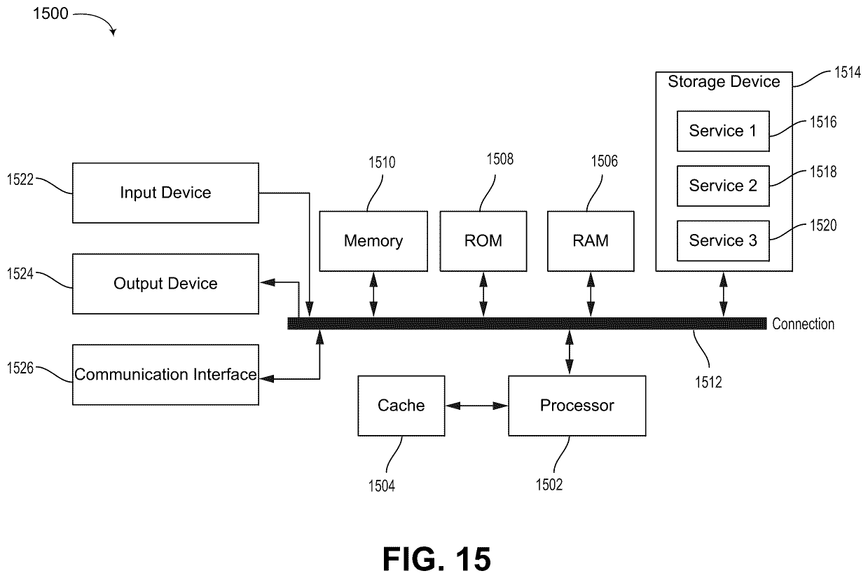

In some examples, as noted previously, the methods described herein (e.g., process 1200 of FIG. 12A, process 1220 of FIG. 12B and/or other methods described herein) can be performed, in whole or in part, by a computing device or apparatus. In one example, one or more of the methods can be performed by system 400 of FIG. 4 or by another system or device. In another example, one or more of the methods (e.g., process 1200, process 1220 and/or other methods described herein) can be performed, in whole or in part, by the computing-device architecture 1500 shown in FIG. 15. For instance, a computing device with the computing-device architecture 1500 shown in FIG. 15 can include, or be included in, the components of the system 400 of FIG. 4, time-step motion-vector projector 430 of FIG. 4 and FIG. 5, motion-vector projector 506 of FIG. 5 and FIG. 7, and/or mask modulator 512 of FIG. 5 and FIG. 11 and can implement the operations of process 1200, process 1220 and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other types of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1200, process 1220 and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1200, process 1220 and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

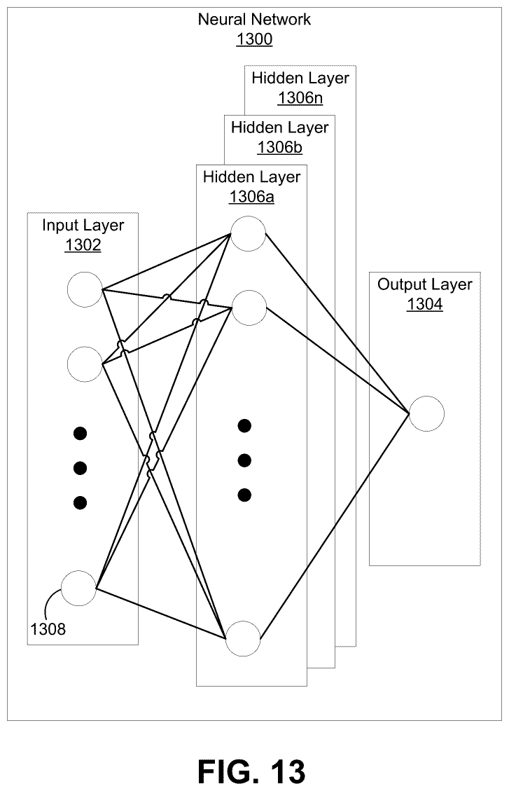

FIG. 13 is an illustrative example of a neural network 1300 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1300 may be an example of, or can implement, motion estimator 202 of FIG. 2A, and FIG. 2B, frame renderer 204 of FIG. 2A and FIG. 2B, motion estimator 402 of FIG. 4, frame renderer 404 of FIG. 4.

An input layer 1302 includes input data. In one illustrative example, input layer 1302 can include data representing input frame 210, input frame 218, metadata 220, time step 222a, and/or time steps 222b of FIG. 2A and/or FIG. 2B, motion vectors 224a and mask 226a of FIG. 2A, motion vectors 224b and masks 226b of FIG. 2B, and motion vectors 432 and masks 434 of FIG. 4. Neural network 1300 includes multiple hidden layers, for example, hidden layers 1306a, 1306b, through 1306n. The hidden layers 1306a, 1306b, through hidden layer 1306n include “n” number of hidden layers, where “n” is an integer greater than or equal to one. The number of hidden layers can be made to include as many layers as needed for the given application. Neural network 1300 further includes an output layer 1304 that provides an output resulting from the processing performed by the hidden layers 1306a, 1306b, through 1306n. In one illustrative example, output layer 1304 can provide motion vectors 224a and mask 226a of FIG. 2A, motion vectors 224b and masks 226b of FIG. 2B, interpolated frame 214 of FIG. 2A and FIG. 2B, interpolated frame 212, interpolated frame 214, and/or interpolated frame 216 of FIG. 2A and FIG. 2B, and frame 412, frame 414, and/or frame 416 of FIG. 4.

Neural network 1300 may be, or may include, a multi-layer neural network of interconnected nodes. Each node can represent a piece of information. Information associated with the nodes is shared among the different layers and each layer retains information as information is processed. In some cases, neural network 1300 can include a feed-forward network, in which case there are no feedback connections where outputs of the network are fed back into itself. In some cases, neural network 1300 can include a recurrent neural network, which can have loops that allow information to be carried across nodes while reading in input.

Information can be exchanged between nodes through node-to-node interconnections between the various layers. Nodes of input layer 1302 can activate a set of nodes in the first hidden layer 1306a. For example, as shown, each of the input nodes of input layer 1302 is connected to each of the nodes of the first hidden layer 1306a. The nodes of first hidden layer 1306a can transform the information of each input node by applying activation functions to the input node information. The information derived from the transformation can then be passed to and can activate the nodes of the next hidden layer 1306b, which can perform their own designated functions. Example functions include convolutional, up-sampling, data transformation, and/or any other suitable functions. The output of the hidden layer 1306b can then activate nodes of the next hidden layer, and so on. The output of the last hidden layer 1306n can activate one or more nodes of the output layer 1304, at which an output is provided. In some cases, while nodes (e.g., node 1308) in neural network 1300 are shown as having multiple output lines, a node has a single output and all lines shown as being output from a node represent the same output value.

In some cases, each node or interconnection between nodes can have a weight that is a set of parameters derived from the training of neural network 1300. Once neural network 1300 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1300 to be adaptive to inputs and able to learn as more and more data is processed.

Neural network 1300 may be pre-trained to process the features from the data in the input layer 1302 using the different hidden layers 1306a, 1306b, through 1306n in order to provide the output through the output layer 1304. In an example in which neural network 1300 is used to identify features in images, neural network 1300 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0].

In some cases, neural network 1300 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1300 is trained well enough so that the weights of the layers are accurately tuned.

For the example of identifying objects in images, the forward pass can include passing a training image through neural network 1300. The weights are initially randomized before neural network 1300 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1300, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1300 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1300 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and f denotes a learning rate. The learning rate can be set to any suitable value, with a high learning rate including larger weight updates and a lower value indicating smaller weight updates.

Neural network 1300 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1300 can include any other deep network other than a CNN, such as an autoencoder, a deep belief nets (DBNs), a Recurrent Neural Networks (RNNs), among others.

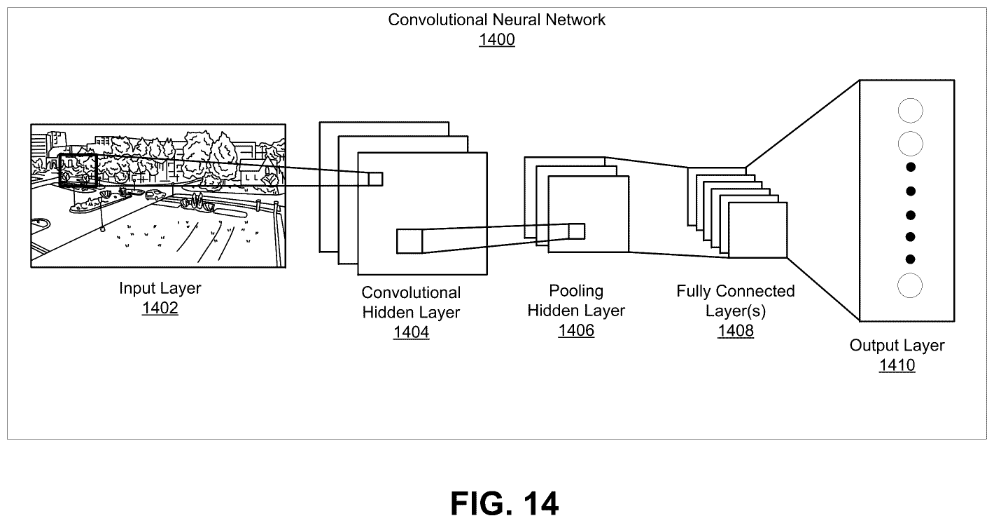

FIG. 14 is an illustrative example of a convolutional neural network (CNN) 1400. The input layer 1402 of the CNN 1400 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1404, an optional non-linear activation layer, a pooling hidden layer 1406, and fully connected layer 1408 (which fully connected layer 1408 can be hidden) to get an output at the output layer 1410. While only one of each hidden layer is shown in FIG. 14, one of ordinary skill will appreciate that multiple convolutional hidden layers, non-linear layers, pooling hidden layers, and/or fully connected layers can be included in the CNN 1400. As previously described, the output can indicate a single class of an object or can include a probability of classes that best describe the object in the image.

The first layer of the CNN 1400 can be the convolutional hidden layer 1404. The convolutional hidden layer 1404 can analyze image data of the input layer 1402. Each node of the convolutional hidden layer 1404 is connected to a region of nodes (pixels) of the input image called a receptive field. The convolutional hidden layer 1404 can be considered as one or more filters (each filter corresponding to a different activation or feature map), with each convolutional iteration of a filter being a node or neuron of the convolutional hidden layer 1404. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1404. Each connection between a node and a receptive field for that node learns a weight and, in some cases, an overall bias such that each node learns to analyze its particular local receptive field in the input image. Each node of the convolutional hidden layer 1404 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1404 is due to each node of the convolutional layer being applied to its corresponding receptive field. For example, a filter of the convolutional hidden layer 1404 can begin in the top-left corner of the input image array and can convolve around the input image. As noted above, each convolutional iteration of the filter can be considered a node or neuron of the convolutional hidden layer 1404. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1404. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1404.

The mapping from the input layer to the convolutional hidden layer 1404 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1404 can include several activation maps in order to identify multiple features in an image. The example shown in FIG. 14 includes three activation maps. Using three activation maps, the convolutional hidden layer 1404 can detect three different kinds of features, with each feature being detectable across the entire image.

In some examples, a non-linear hidden layer can be applied after the convolutional hidden layer 1404. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1400 without affecting the receptive fields of the convolutional hidden layer 1404.

The pooling hidden layer 1406 can be applied after the convolutional hidden layer 1404 (and after the non-linear hidden layer when used). The pooling hidden layer 1406 is used to simplify the information in the output from the convolutional hidden layer 1404. For example, the pooling hidden layer 1406 can take each activation map output from the convolutional hidden layer 1404 and generates a condensed activation map (or feature map) using a pooling function. Max-pooling is one example of a function performed by a pooling hidden layer. Other forms of pooling functions be used by the pooling hidden layer 1406, such as average pooling, L2-norm pooling, or other suitable pooling functions. A pooling function (e.g., a max-pooling filter, an L2-norm filter, or other suitable pooling filter) is applied to each activation map included in the convolutional hidden layer 1404. In the example shown in FIG. 14, three pooling filters are used for the three activation maps in the convolutional hidden layer 1404.

In some examples, max-pooling can be used by applying a max-pooling filter (e.g., having a size of 2×2) with a stride (e.g., equal to a dimension of the filter, such as a stride of 2) to an activation map output from the convolutional hidden layer 1404. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1404 having a dimension of 24×24 nodes, the output from the pooling hidden layer 1406 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1400.

The final layer of connections in the network is a fully-connected layer that connects every node from the pooling hidden layer 1406 to every one of the output nodes in the output layer 1410. Using the example above, the input layer includes 28×28 nodes encoding the pixel intensities of the input image, the convolutional hidden layer 1404 includes 3×24×24 hidden feature nodes based on application of a 5×5 local receptive field (for the filters) to three activation maps, and the pooling hidden layer 1406 includes a layer of 3×12×12 hidden feature nodes based on application of max-pooling filter to 2×2 regions across each of the three feature maps. Extending this example, the output layer 1410 can include ten output nodes. In such an example, every node of the 3×12×12 pooling hidden layer 1406 is connected to every node of the output layer 1410.

The fully connected layer 1408 can obtain the output of the previous pooling hidden layer 1406 (which should represent the activation maps of high-level features) and determines the features that most correlate to a particular class. For example, the fully connected layer 1408 can determine the high-level features that most strongly correlate to a particular class and can include weights (nodes) for the high-level features. A product can be computed between the weights of the fully connected layer 1408 and the pooling hidden layer 1406 to obtain probabilities for the different classes. For example, if the CNN 1400 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1410 can include an M-dimensional vector (in the prior example, M=10). M indicates the number of classes that the CNN 1400 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 15 illustrates an example computing-device architecture 1500 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1500 may include, implement, or be included in any or all of system 400 of FIG. 4, time-step motion-vector projector 430 of FIG. 4 and FIG. 5, motion-vector projector 506 of FIG. 5 and FIG. 7, and/or mask modulator 512 of FIG. 5 and FIG. 11 and/or other devices, modules, or systems described herein. Additionally or alternatively, computing-device architecture 1500 may be configured to perform process 1200, process 1220 and/or other process described herein.

The components of computing-device architecture 1500 are shown in electrical communication with each other using connection 1512, such as a bus. The example computing-device architecture 1500 includes a processing unit (CPU or processor) 1502 and computing device connection 1512 that couples various computing device components including computing device memory 1510, such as read only memory (ROM) 1508 and random-access memory (RAM) 1506, to processor 1502.

Computing-device architecture 1500 can include a cache of high-speed memory connected directly with, in close proximity to, or integrated as part of processor 1502. Computing-device architecture 1500 can copy data from memory 1510 and/or the storage device 1514 to cache 1504 for quick access by processor 1502. In this way, the cache can provide a performance boost that avoids processor 1502 delays while waiting for data. These and other modules can control or be configured to control processor 1502 to perform various actions. Other computing device memory 1510 may be available for use as well. Memory 1510 can include multiple different types of memory with different performance characteristics. Processor 1502 can include any general-purpose processor and a hardware or software service, such as service 1 1516, service 2 1518, and service 3 1520 stored in storage device 1514, configured to control processor 1502 as well as a special-purpose processor where software instructions are incorporated into the processor design. Processor 1502 may be a self-contained system, containing multiple cores or processors, a bus, memory controller, cache, etc. A multi-core processor may be symmetric or asymmetric.

To enable user interaction with the computing-device architecture 1500, input device 1522 can represent any number of input mechanisms, such as a microphone for speech, a touch-sensitive screen for gesture or graphical input, keyboard, mouse, motion input, speech and so forth. Output device 1524 can also be one or more of a number of output mechanisms known to those of skill in the art, such as a display, projector, television, speaker device, etc. In some instances, multimodal computing devices can enable a user to provide multiple types of input to communicate with computing-device architecture 1500. Communication interface 1526 can generally govern and manage the user input and computing device output. There is no restriction on operating on any particular hardware arrangement and therefore the basic features here may easily be substituted for improved hardware or firmware arrangements as they are developed.

Storage device 1514 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1506, read only memory (ROM) 1508, and hybrids thereof. Storage device 1514 can include services 1516, 1518, and 1520 for controlling processor 1502. Other hardware or software modules are contemplated. Storage device 1514 can be connected to the computing device connection 1512. In one aspect, a hardware module that performs a particular function can include the software component stored in a computer-readable medium in connection with the necessary hardware components, such as processor 1502, connection 1512, output device 1524, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for interpolating image data, the apparatus comprising: at least one memory; and at least one processor coupled to the at least one memory and configured to: process a first image frame and a second image frame using a motion estimator to generate first motion vectors, wherein the motion estimator comprises a machine-learning model trained to generate motion vectors based on image frames; project the first motion vectors to generate second motion vectors; and generate a third image frame based on the first image frame, the second image frame, and the second motion vectors.

Aspect 2. The apparatus of aspect 1, wherein the first motion vectors are generated based on a time step between a first time associated with the first image frame and a second time associated with the second image frame.

Aspect 3. The apparatus of any one of aspects 1 or 2, wherein the at least one processor is configured to generate a fourth image frame based on the first image frame, the second image frame, and the first motion vectors.

Aspect 4. The apparatus of aspect 3, wherein the first motion vectors comprise backward motion vectors suggestive of differences between pixels of the fourth image frame and pixels of the first image frame and forward motion vectors suggestive of differences between pixels of the fourth image frame and pixels of the second image frame.

Aspect 5. The apparatus of any one of aspects 1 to 4, wherein the second motion vectors comprise backward motion vectors suggestive of differences between pixels of the third image frame and pixels of the first image frame and forward motion vectors suggestive of differences between pixels of the third image frame and the pixels of the second image frame.

Aspect 6. The apparatus of any one of aspects 1 to 5, wherein the first motion vectors are projected based on a frame-interpolation ratio based on an input frame rate and an output frame rate.

Aspect 7. The apparatus of aspect 6, wherein, to project the first motion vectors, the at least one processor is configured to linearly scale the first motion vectors based on the frame-interpolation ratio to generate scaled motion vectors.

Aspect 8. The apparatus of aspect 7, wherein, to project the first motion vectors, the at least one processor is configured to update associations between the scaled motion vectors and pixel positions.

Aspect 9. The apparatus of aspect 8, wherein, to project the first motion vectors, the at least one processor is configured to resolve gaps in the associations between the scaled motion vectors and the pixel positions.

Aspect 10. The apparatus of aspect 9, wherein, to resolve gaps in the associations between the scaled motion vectors and the pixel positions, the at least one processor is configured to fill the gaps with prior first motion vectors.

Aspect 11. The apparatus of any one of aspects 8 to 10, wherein the at least one processor is configured to resolve conflicts in the associations between the scaled motion vectors and the pixel positions.

Aspect 12. The apparatus of aspect 11, wherein the at least one processor is configured to generate a confidence mask based on the first motion vectors, wherein the conflicts are resolved based on the confidence mask.

Aspect 13. The apparatus of aspect 12, wherein the conflicts are resolved by selecting a scaled motion vector associated with a higher confidence value in the confidence mask over a scaled motion vector associated with a lower confidence value in the confidence mask.

Aspect 14. The apparatus of any one of aspects 12 or 13, wherein, to generate the confidence mask, the at least one processor is configured to: determine first-to-second motion vectors based on the first image frame and the second image frame; determine second-to-first motion vectors based on the second image frame and the first image frame; and compare the first-to-second motion vectors to the second-to-first motion vectors.

Aspect 15. The apparatus of any one of aspects 11 to 14, wherein the conflicts are resolved based on lengths of conflicting scaled motion vectors.

Aspect 16. The apparatus of any one of aspects 8 to 15, wherein the at least one processor is configured to: process the first image frame and the second image frame using the motion estimator to generate a first mask; and project the first mask to generate a second mask; wherein to project the first mask, the at least one processor is configured to update mask values of the first mask based on the updated associations between the scaled motion vectors and the pixel positions; and wherein the third image frame is generated further based on the second mask.

Aspect 17. The apparatus of aspect 16, wherein the at least one processor is configured to, when projecting the first mask, exclude from updating mask values that are within a threshold range, wherein the threshold range is indicative of occlusion in at least one of the first image frame or the second image frame.

Aspect 18. The apparatus of any one of aspects 1 to 17, wherein the at least one processor is configured to: process the first image frame and the second image frame using the motion estimator to generate a first mask; and project the first mask to generate a second mask; wherein the third image frame is generated further based on the second mask.

Aspect 19. The apparatus of aspect 18, wherein the at least one processor is configured to linearly scale values of the first mask based on a time step between a first time associated with the first image frame and a second time associated with the second image frame to generate the second mask.

Aspect 20. The apparatus of aspect 19, wherein the at least one processor is configured to scale the values of the second mask based on values of the first mask.

Aspect 21. A method for interpolating image data, the method comprising: processing a first image frame and a second image frame using a motion estimator to generate first motion vectors, wherein the motion estimator comprises a machine-learning model trained to generate motion vectors based on image frames; projecting the first motion vectors to generate second motion vectors; and generating a third image frame based on the first image frame, the second image frame, and the second motion vectors.

Aspect 22. The method of aspect 21, wherein the first motion vectors are generated based on a time step between a first time associated with the first image frame and a second time associated with the second image frame.

Aspect 23. The method of any one of aspects 21 or 22, further comprising generating a fourth image frame based on the first image frame, the second image frame, and the first motion vectors.

Aspect 24. The method of aspect 23, wherein the first motion vectors comprise backward motion vectors suggestive of differences between pixels of the fourth image frame and pixels of the first image frame and forward motion vectors suggestive of differences between pixels of the fourth image frame and pixels of the second image frame.

Aspect 25. The method of any one of aspects 21 to 24, wherein the second motion vectors comprise backward motion vectors suggestive of differences between pixels of the third image frame and pixels of the first image frame and forward motion vectors suggestive of differences between pixels of the third image frame and the pixels of the second image frame.

Aspect 26. The method of any one of aspects 21 to 25, wherein the first motion vectors are projected based on a frame-interpolation ratio based on an input frame rate and an output frame rate.

Aspect 27. The method of aspect 26, wherein projecting the first motion vector comprises linearly scaling the first motion vectors based on the frame-interpolation ratio to generate scaled motion vectors.

Aspect 28. The method of aspect 27, wherein projecting the first motion vectors comprises updating associations between the scaled motion vectors and pixel positions.

Aspect 29. The method of aspect 28, wherein projecting the first motion vectors comprises resolving gaps in the associations between the scaled motion vectors and the pixel positions.

Aspect 30. The method of aspect 29, wherein resolving gaps in the associations between the scaled motion vectors and the pixel positions comprises filling the gaps with prior first motion vectors.

Aspect 31. The method of any one of aspects 28 to 30, further comprising resolving conflicts in the associations between the scaled motion vectors and the pixel positions.

Aspect 32. The method of aspect 31, further comprising generating a confidence mask based on the first motion vectors, wherein the conflicts are resolved based on the confidence mask.

Aspect 33. The method of aspect 32, wherein the conflicts are resolved by selecting a scaled motion vector associated with a higher confidence value in the confidence mask over a scaled motion vector associated with a lower confidence value in the confidence mask.

Aspect 34. The method of any one of aspects 32 or 33, wherein generating the confidence mask comprises: determining first-to-second motion vectors based on the first image frame and the second image frame; determining second-to-first motion vectors based on the second image frame and the first image frame; and comparing the first-to-second motion vectors to the second-to-first motion vectors.

Aspect 35. The method of any one of aspects 31 to 34, wherein the conflicts are resolved based on lengths of conflicting scaled motion vectors.

Aspect 36. The method of any one of aspects 28 to 35, further comprising: processing the first image frame and the second image frame using the motion estimator to generate a first mask; and projecting the first mask to generate a second mask; wherein projecting the first mask comprises updating mask values of the first mask based on the updated associations between the scaled motion vectors and the pixel positions; and wherein the third image frame is generated further based on the second mask.

Aspect 37. The method of aspect 36, further comprising, when projecting the first mask, excluding from updating mask values that are within a threshold range, wherein the threshold range is indicative of occlusion in at least one of the first image frame or the second image frame.

Aspect 38. The method of any one of aspects 21 to 37, further comprising: processing the first image frame and the second image frame using the motion estimator to generate a first mask; and projecting the first mask to generate a second mask; wherein the third image frame is generated further based on the second mask.

Aspect 39. The method of aspect 38, further comprising linearly scaling values of the first mask based on a time step between a first time associated with the first image frame and a second time associated with the second image frame to generate the second mask.

Aspect 40. The method of aspect 39, further comprising scaling the values of the second mask based on values of the first mask.

Aspect 41. A non-transitory computer-readable storage medium having stored thereon instructions that, when executed by at least one processor, cause the at least one processor to perform operations according to any of aspects 21 to 40.

Aspect 42. An apparatus for providing virtual content for display, the apparatus comprising one or more means for perform operations according to any of aspects 21 to 40.

What is claimed is:

1. An apparatus for interpolating image data, the apparatus comprising:
at least one memory; and
at least one processor coupled to the at least one memory and configured to:
process a first image frame and a second image frame using a motion estimator to generate first motion vectors, wherein the motion estimator comprises a machine-learning model trained to generate motion vectors based on image frames;
project the first motion vectors to generate second motion vectors; and
generate a third image frame based on the first image frame, the second image frame, and the second motion vectors.

2. The apparatus of claim 1, wherein the first motion vectors are generated based on a time step between a first time associated with the first image frame and a second time associated with the second image frame.

3. The apparatus of claim 1, wherein the at least one processor is configured to generate a fourth image frame based on the first image frame, the second image frame, and the first motion vectors.

4. The apparatus of claim 3, wherein the first motion vectors comprise backward motion vectors suggestive of differences between pixels of the fourth image frame and pixels of the first image frame and forward motion vectors suggestive of differences between pixels of the fourth image frame and pixels of the second image frame.

5. The apparatus of claim 1, wherein the second motion vectors comprise backward motion vectors suggestive of differences between pixels of the third image frame and pixels of the first image frame and forward motion vectors suggestive of differences between pixels of the third image frame and the pixels of the second image frame.

6. The apparatus of claim 1, wherein the first motion vectors are projected based on a frame-interpolation ratio based on an input frame rate and an output frame rate.

7. The apparatus of claim 6, wherein, to project the first motion vectors, the at least one processor is configured to linearly scale the first motion vectors based on the frame-interpolation ratio to generate scaled motion vectors.

8. The apparatus of claim 7, wherein, to project the first motion vectors, the at least one processor is configured to update associations between the scaled motion vectors and pixel positions.

9. The apparatus of claim 8, wherein, to project the first motion vectors, the at least one processor is configured to resolve gaps in the associations between the scaled motion vectors and the pixel positions.

10. The apparatus of claim 9, wherein, to resolve gaps in the associations between the scaled motion vectors and the pixel positions, the at least one processor is configured to fill the gaps with prior first motion vectors.

11. The apparatus of claim 8, wherein the at least one processor is configured to resolve conflicts in the associations between the scaled motion vectors and the pixel positions.

12. The apparatus of claim 11, wherein the at least one processor is configured to generate a confidence mask based on the first motion vectors, wherein the conflicts are resolved based on the confidence mask.

13. The apparatus of claim 12, wherein the conflicts are resolved by selecting a scaled motion vector associated with a higher confidence value in the confidence mask over a scaled motion vector associated with a lower confidence value in the confidence mask.

14. The apparatus of claim 12, wherein, to generate the confidence mask, the at least one processor is configured to:
determine first-to-second motion vectors based on the first image frame and the second image frame;
determine second-to-first motion vectors based on the second image frame and the first image frame; and
compare the first-to-second motion vectors to the second-to-first motion vectors.

15. The apparatus of claim 11, wherein the conflicts are resolved based on lengths of conflicting scaled motion vectors.

16. The apparatus of claim 8, wherein the at least one processor is configured to:
process the first image frame and the second image frame using the motion estimator to generate a first mask; and
project the first mask to generate a second mask;
wherein to project the first mask, the at least one processor is configured to update mask values of the first mask based on the updated associations between the scaled motion vectors and the pixel positions; and
wherein the third image frame is generated further based on the second mask.

17. The apparatus of claim 16, wherein the at least one processor is configured to, when projecting the first mask, exclude from updating mask values that are within a threshold range, wherein the threshold range is indicative of occlusion in at least one of the first image frame or the second image frame.

18. The apparatus of claim 1, wherein the at least one processor is configured to:
process the first image frame and the second image frame using the motion estimator to generate a first mask; and
project the first mask to generate a second mask;
wherein the third image frame is generated further based on the second mask.

19. The apparatus of claim 18, wherein the at least one processor is configured to linearly scale values of the first mask based on a time step between a first time associated with the first image frame and a second time associated with the second image frame to generate the second mask.

20. The apparatus of claim 19, wherein the at least one processor is configured to scale the values of the second mask based on values of the first mask.
